(19) United States
(12) Patent Application Publication
(10) Pub. No.: US 2026/0297308 A1
(43) Pub. Date: Oct. 1, 2026

(54) SOLUTION-PHASE POLYMERIZATION PROCESS

(71) Applicant: NOVA Chemicals (International) S.A., Fribourg (CH)

(72) Inventors: Stephen SALOMONS, Calgary (CA); Fazle SIBTAIN, Calgary (CA); Mark HOIDAS, Calgary (CA); Stephen HUBER, Calgary (CA); Shivendra GOYAL, Calgary (CA); Eric CLAVELLE, Calgary (CA)

(73) Assignee: NOVA Chemicals (International) S.A., Fribourg (CH)

(21) Appl. No.: 19/479,844

(22) PCT Filed: May 12, 2023
(86) PCT No.: PCT/EP2023/062831

§ 371 Date: Oct. 29, 2025

(51) Int. Cl. C08L 23/0807

(52) U.S. Cl. CPC C08L 23/0815; C08L 2205/025; C08L 2314/02; C08L 2314/06

(57) ABSTRACT

The present disclosure describes a continuous solution-phase polymerization process to provide an ethylene polymer product comprising a first ethylene polymer and a second ethylene polymer. The continuous solution-phase polymerization process is carried out by injecting a bridged metallocene catalyst formulation, ethylene and process solvent in a first reactor, and by injecting a first heterogenous catalyst formulation and a second combined feed stream comprising ethylene and process solvent in a second reactor. The second feed stream is injected into the second reactor at defined ethylene concentration and temperature ranges resulting in reduced frequency of occurrence of non-oxidized polyethylene defects in the final ethylene polymer product.

### TECHNICAL FIELD

Provided herein is a continuous solution-phase polymerization process utilizing at least two reactors employing a bridged metallocene catalyst formulation and a first heterogeneous catalyst formulation to produce multicomponent ethylene polymer products which are characterized by having reduced level of non-oxidized polyethylene defects.

### BACKGROUND

It is known to those of ordinary experience that it is desired to provide ethylene polymer products with broadened melting interval which is specifically advantageous in improving performance in film applications—e.g., in heat-sealing applications. One method to access such ethylene polymer products is to use two or more distinct polymerization catalysts in one or more polymerization reactors. For example, the use of metallocene type and heterogenous type polymerization catalysts in at least two distinct solution-phase polymerization reactors is known. These processes may involve formation of a very small amount of an ultra-high molecular weight polymer (i.e., polymer species with a weight-average molecular weight exceeding 10⁶ g/mol) which may further have a chemical composition distinct from the bulk ethylene polymer product being made. These species are generally immiscible with the ethylene polymer product and become visual defects in thin wall articles and films. Hence, there remains a need for an improved solution-phase polymerization processes to reduce the propensity for introduction of these ultra-high molecular weight species.

### SUMMARY

Provided in a first aspect of the present disclosure is a continuous solution-phase polymerization process to provide an ethylene polymer product, wherein the ethylene polymer product comprises a first ethylene polymer and a second ethylene polymer, the process comprising: a) injecting into a first reactor a bridged metallocene catalyst formulation, a process solvent and ethylene to produce a first exit stream containing the first ethylene polymer in the process solvent; and b) passing the first exit stream into a second reactor and injecting into the second reactor a first heterogeneous catalyst formulation and a second feed stream to produce a second exit stream containing the second ethylene polymer and the first ethylene polymer in the process solvent, wherein the second feed stream is produced by combining the process solvent and ethylene; wherein concentration of ethylene in the second feed stream is less than or equal to 25 weight percent based on the total weight of the second feed stream injected into the second reactor in unit of time, and wherein the second feed stream has a temperature of greater than or equal to 60° C. and less than or equal to 90° C.

Provided in a first aspect of the present disclosure is a continuous solution-phase polymerization process to provide an ethylene polymer product, wherein the ethylene polymer product comprises a first ethylene polymer and a second ethylene polymer, the process comprising: a) injecting into a first reactor a bridged metallocene catalyst formulation, a process solvent and ethylene to produce a first exit stream containing the first ethylene polymer in the process solvent; injecting into a second reactor a first heterogeneous catalyst formulation and a second feed stream to produce a second exit stream containing the second ethylene polymer in the process solvent, wherein the second feed stream is produced by combining the process solvent and ethylene; and c) combining the first exit stream and the second exit stream to form a third exit stream; wherein concentration of ethylene in the second feed stream is less than or equal to 25 weight percent based on the total weight of the second feed stream injected into the second reactor in unit of time, and wherein the second feed stream injected into the second reactor has a temperature of greater than or equal to 60° C. and less than or equal to 90° C.

In some embodiments, the process further comprises injecting into the first reactor one or more C₃ to C₁₀ α-olefins.

In some embodiments, the second feed stream further comprises one or more C₃ to C₁₀ α-olefins at a relative concentration to ethylene of greater than or equal to 0.15 and less than or equal to 2, based on the ratio of ethylene weight precent and the one or more C₃ to C₁₀ α-olefins weigh precent in the second feed stream injected to the second reactor.

In some embodiments, the C₃ to C₁₀ α-olefins are selected from 1-hexene, 1-octene or a mixture of 1-hexene and 1-octene.

In some embodiments, the second feed stream injected into the second reactor comprises hydrogen at a concentration of 0.1 to 20 parts per million based on the total weight of the second feed stream injected into the second reactor in unit of time.

In some embodiments, the bridged metallocene catalyst formulation comprises: a component A defined by formula (I):

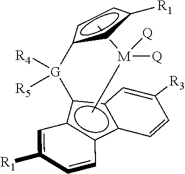

wherein M is a group 4 metal selected from titanium, zirconium or hafnium; G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand; an alumoxane co-catalyst; a boron ionic activator; and optionally, a hindered phenol.

In some embodiments, the bridged metallocene catalyst formulation comprises: a component A defined by formula (II):

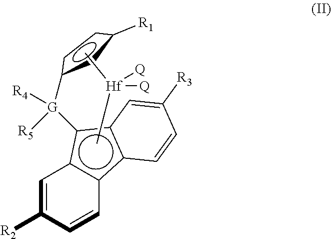

wherein G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand; an alumoxane co-catalyst; a boron ionic activator; and optionally, a hindered phenol.

In some embodiments, the boron ionic activator and the component A in the first reactor have a molar ratio from 0.1:1 to 10:1; the alumoxane co-catalyst and the component A in the first reactor have a molar ratio from 1:1 to 1000:1; and the hindered phenol, if present, and the alumoxane cocatalyst in the first reactor have a molar ratio of from 0.0:1 to 10:1.

In some embodiments, the alumoxane co-catalyst is methylalumoxane.

In some embodiments, the boron ionic activator is trityl tetrakis(pentafluoro-phenyl) borate.

In some embodiments, the first heterogeneous catalyst formulation is a first inline Ziegler-Natta catalyst formulation.

In some embodiments, the first inline Ziegler-Natta catalyst formulation is formed in an inline process, the inline process comprising: forming a first product mixture in a first stage of a first heterogeneous catalyst assembly by combining a stream S1 and a stream S2 and allowing the first product mixture to equilibrate for a HUT-1 seconds; wherein the stream S1 comprises a magnesium compound and an aluminum alkyl in the process solvent, wherein the stream S2 comprises a chloride compound in the process solvent; forming a second product mixture in a second stage of the first heterogeneous catalyst assembly by combining the first product mixture with a stream S3 and allowing the second product mixture to equilibrate for a HUT-2 seconds; wherein the stream S3 comprises a metal compound in the process solvent; and forming the first inline Ziegler-Natta catalyst formulation in a third stage of the first heterogeneous catalyst assembly by combining the second product mixture with a stream S4 and allowing the first inline Ziegler-Natta catalyst formulations to equilibrate for a HUT-3 seconds prior to injection into the second reactor, wherein the stream S4 comprises an alkyl aluminum co-catalyst in the process solvent.

In some embodiments, the first inline Ziegler-Natta catalyst formulation is formed in an inline process, the inline process comprising: forming a first product mixture in a first stage of a first heterogeneous catalyst assembly by combining a stream S1 and a stream S2 and allowing the first product mixture to equilibrate for a HUT-1 seconds; wherein the stream S1 comprises a magnesium compound and an aluminum alkyl in the process solvent, wherein the stream S2 comprises a chloride compound in the process solvent; forming a second product mixture in a second stage of the first heterogeneous catalyst assembly by combining the first product mixture with a stream S3 and allowing the second product mixture to equilibrate for a HUT-2 seconds; wherein the stream S3 comprises a metal compound in the process solvent; forming the first inline Ziegler-Natta catalyst formulation inside the second reactor, wherein: the second product mixture is equilibrated for an additional HUT-3 seconds in a third stage of the first heterogeneous catalyst assembly and injected into the second reactor; and a stream S4 comprising an alkyl aluminum co-catalyst in the process solvent is independently injected into the second reactor.

In some embodiments, the HUT-1 is from about 5 seconds to about 70 seconds, the HUT-2 is from about 2 seconds to about 50 seconds and the HUT-3 is from about 0.5 to about 15 seconds.

In some embodiments, the magnesium compound is defined by the formula Mg(R¹)₂, wherein the R¹ groups may be the same or different; the aluminum alkyl is defined by the formula Al(R³)₃, wherein the R³ groups may be the same or different; the chloride compound is defined by the formula R²Cl; the metal compound is defined by the formulas M*(X)ₙ or M*O(X)ₙ, wherein M* represents titanium, zirconium, hafnium, vanadium, niobium, tantalum, chromium, molybdenum, tungsten, manganese, technetium, rhenium, iron, ruthenium, osmium or mixtures thereof, O represents oxygen, X represents chloride or bromide and n is an integer that satisfies the oxidation state of the metal M, and; the alkyl aluminum co-catalyst is defined by the formula Al(R⁴)ₚ(OR⁵)_{q}(X)ᵣ, wherein the R⁴ groups may be the same or different, the OR⁵ groups may be the same or different and (p+q+r)=3, with the proviso that p is greater than 0; wherein R¹, R², R³, R⁴ and R⁵ represent hydrocarbyl groups having from 1 to 10 carbon atoms.

In some embodiments, the metal M* in the metal compound represents titanium, zirconium, hafnium, vanadium, chromium or mixtures thereof.

In some embodiments, the concentration of ethylene in the second feed stream injected into the second reactor is less than 21 weight percent and greater than 15 weight percent based on the total weight of the second feed stream injected into the second reactor in unit of time.

In some embodiments, the first exit stream has a first temperature T₁ and the second exit stream has second temperature T₂, and wherein T₁ and T₂ satisfy the inequality 45<T₂−T₁<70.

In some embodiments, the process further comprises a step of passing the second exit stream from the step b) of the process as defined in the first aspect into a third reactor and optionally injecting into the third reactor ethylene, a process solvent, one or more α-olefins, hydrogen and a second heterogenous catalyst formulation to produce a fourth exit stream containing an optional third ethylene polymer, the second ethylene polymer and the first ethylene polymer in the process solvent.

In some embodiments, the process further comprises a step of passing the third exit stream from the step c) of the process as defined in the second aspect into a third reactor and optionally injecting into the third reactor ethylene, a process solvent, one or more α-olefins, hydrogen and a second heterogenous catalyst formulation to produce a fourth exit stream containing an optional third ethylene polymer, the second ethylene polymer and the first ethylene polymer in the process solvent.

In some embodiments, the second heterogenous catalyst formulation, if present, is the first inline Ziegler-Natta catalyst.

In some embodiments, the first reactor and the second reactor are operated adiabatically.

In some embodiments, the third reactor is operated adiabatically.

### BRIEF DESCRIPTION OF THE FIGURES

FIG. 1 shows a continuous solution-phase polymerization process according to an embodiment of the present disclosure.

### DEFINITIONS OF TERMS

Other than in the examples or where otherwise indicated, all numbers or expressions referring to quantities of ingredients, process conditions, etc., used in the specification and claims are to be understood as modified in all instances by the term “about”. Accordingly, unless indicated to the contrary, the numerical parameters set forth in the following specification and attached claims are approximations that can vary depending upon the desired properties that the various embodiments desire to obtain. At the very least, and not as an attempt to limit the application of the doctrine of equivalents to the scope of the claims, each numerical parameter should at least be construed in light of the number of reported significant digits and by applying ordinary rounding techniques. The numerical values set forth in the specific examples are reported as precisely as possible. Any numerical values, however, inherently contain certain errors necessarily resulting from the standard deviation found in their respective testing measurements.

It should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10.

Because the disclosed numerical ranges are continuous, they include every value between the minimum and maximum values. Unless expressly indicated otherwise, the various numerical ranges specified in this application are approximations.

All compositional ranges expressed herein are limited in total to and do not exceed 100 percent (volume percent or weight percent) in practice. Where multiple components can be present in a composition, the sum of the maximum amounts of each component can exceed 100 percent, with the understanding that, and as those skilled in the art readily understand, that the amounts of the components actually used will conform to the maximum of 100 percent.

In order to form a more complete understanding of this disclosure the following terms are defined and should be used with the accompanying FIGURES and the description of the various embodiments throughout.

As used herein, the term “monomer” refers to a small molecule that may chemically react and become chemically bonded with itself or other monomers to form a polymer.

As used herein, the term “α-olefin” or “alpha-olefin” is used to describe a monomer having a linear hydrocarbon chain containing from 3 to 20 carbon atoms having a double bond at one end of the chain; an equivalent term is “linear α-olefin”.

As used herein, the term “ethylene polymer”, refers to macromolecules produced from ethylene monomers and optionally one or more additional monomers; regardless of the specific catalyst or specific process used to make the ethylene polymer.

In the polyethylene art, the one or more additional monomers are called “comonomer(s)” and often include α-olefins. The term “homopolymer” refers to a polymer that contains only one type of monomer. An “ethylene homopolymer” is made using only ethylene as a polymerizable monomer. The term “copolymer” refers to a polymer that contains two or more types of monomers. An “ethylene copolymer” is made using ethylene and one or more other types of polymerizable monomer.

Common ethylene polymers include high density polyethylene (HDPE), medium density polyethylene (MDPE), linear low-density polyethylene (LLDPE), very low-density polyethylene (VLDPE), ultralow density polyethylene (ULDPE), plastomer and elastomers.

The term “ethylene polymer” also includes ethylene terpolymers which may include two or more comonomers in addition to ethylene. The term “ethylene polymer” also includes combinations of, or blends of, the polymers described above.

The term “heterogeneously branched ethylene polymer” refers to a subset of polymers in the ethylene polymer group that are produced using a heterogeneous catalyst system; non-limiting examples of which include Ziegler-Natta or chromium catalysts, both of which are well known in the art.

The term “homogeneously branched ethylene polymer” refers to a subset of polymers in the ethylene polymer group that are produced using single site catalysts; non-limiting examples of which include unbridged metallocene catalysts, bridged metallocene catalysts and phosphinimine catalysts all of which are well known in the art.

Typically, homogeneously branched ethylene polymers have narrow molecular weight distributions, for example conventional gel permeation chromatography (GPC) Mw/Mn values of less than about 2.8, especially less than about 2.3, although exceptions may arise; Mw and Mn refer to weight- and number-average molecular weights, respectively.

In contrast, the M_{w}/Mₙ of heterogeneously branched ethylene polymers are typically greater than the M_{w}/Mₙ of homogeneous ethylene polymers. In general, homogeneously branched ethylene polymers also have a narrow composition distribution, i.e., each macromolecule within the molecular weight distribution has a similar comonomer content. Frequently, the composition distribution breadth index “CDBI” is used to quantify how the comonomer is distributed within an ethylene polymer, as well as to differentiate ethylene polymers produced with different catalysts or processes.

The “CDBI₅₀” is defined as the percent of ethylene polymer whose composition is within 50 weight percent (wt %) of the median comonomer composition; this definition is consistent with that described in WO 93/03093 assigned to Exxon Chemical Patents Inc. The CDBI₅₀ of an ethylene copolymer can be calculated from TREF (Temperature Rising Elution Fractionation) curves; the TREF method is described in Wild, et al. J. Polym. Sci., Part B, Polym. Phys., Vol. 20 (3), pages 441-455.

Typically, the CDBI₅₀ of homogeneously branched ethylene polymers are greater than about 70% or greater than about 75%. In contrast, the CDBI₅₀ of α-olefin containing heterogeneously branched ethylene polymers are generally lower than the CDBI₅₀ of homogeneous ethylene polymers. For example, the CDBI₅₀ of a heterogeneously branched ethylene polymer may be less than about 75%, or less than about 70%.

It is well known to those skilled in the art, that homogeneously branched ethylene polymers are frequently further subdivided into “linear homogeneous ethylene polymers” and “substantially linear homogeneous ethylene polymers.” A long chain branch is macromolecular in nature, i.e., similar in length to the macromolecule that the long chain branch is attached to. Hereafter, in this disclosure, the term “homogeneously branched polyethylene” or “homogeneously branched ethylene polymer” refers to both linear homogeneous ethylene polymers and substantially linear homogeneous ethylene polymers.

As used herein, the terms “hydrocarbyl”, “hydrocarbyl radical” or “hydrocarbyl group” refers to linear or cyclic, aliphatic, olefinic, acetylenic and aryl (aromatic) radicals comprising hydrogen and carbon that are deficient by one hydrogen.

As used herein, an “alkyl radical” includes linear, branched and cyclic paraffin radicals that are deficient by one hydrogen radical; non-limiting examples include methyl (—CH₃) and ethyl (—CH₂CH₃) radicals. The term “alkenyl radical” refers to linear, branched and cyclic hydrocarbons containing at least one carbon-carbon double bond that is deficient by one hydrogen radical.

As used herein, the term “aryl” group includes phenyl, naphthyl, pyridyl and other radicals whose molecules have an aromatic ring structure; non-limiting examples include naphthylene, phenanthrene and anthracene. An “arylalkyl” group is an alkyl group having an aryl group pendant there from; non-limiting examples include benzyl, phenethyl and tolylmethyl; an “alkylaryl” is an aryl group having one or more alkyl groups pendant there from; non-limiting examples include tolyl, xylyl, mesityl and cumyl.

As used herein, the phrase “heteroatom” includes any atom other than carbon and hydrogen that can be bound to carbon. A “heteroatom-containing group” is a hydrocarbon radical that contains a heteroatom and may contain one or more of the same or different heteroatoms. In one embodiment, a heteroatom-containing group is a hydrocarbyl group containing from 1 to 3 atoms selected from the group consisting of boron, aluminum, silicon, germanium, nitrogen, phosphorous, oxygen and sulfur. Non-limiting examples of heteroatom-containing groups include radicals of imines, amines, oxides, phosphines, ethers, ketones, oxoazolines heterocyclics, oxazolines, thioethers, and the like. The term “heterocyclic” refers to ring systems having a carbon backbone that comprise from 1 to 3 atoms selected from the group consisting of boron, aluminum, silicon, germanium, nitrogen, phosphorous, oxygen and sulfur.

As used herein the term “unsubstituted” means that hydrogen radicals are bounded to the molecular group that follows the term unsubstituted. The term “substituted” means that the group following this term possesses one or more moieties (non hydrogen radicals) that have replaced one or more hydrogen radicals in any position within the group; non-limiting examples of moieties include halogen radicals (F, Cl, Br), hydroxyl groups, carbonyl groups, carboxyl groups, silyl groups, amine groups, phosphine groups, alkoxy groups, phenyl groups, naphthyl groups, C₁ to C₃₀ alkyl groups, C₂ to C₃₀ alkenyl groups, and combinations thereof. Non limiting examples of substituted alkyls and aryls include: acyl radicals, alkyl silyl radicals, alkylamino radicals, alkoxy radicals, aryloxy radicals, alkylthio radicals, dialkylamino radicals, alkoxycarbonyl radicals, aryloxycarbonyl radicals, carbomoyl radicals, alkyl- and dialkyl-carbamoyl radicals, acyloxy radicals, acylamino radicals, arylamino radicals and combinations thereof.

### DETAILED DESCRIPTION

In the present disclosure, a continuous solution-phase polymerization process provides an ethylene polymer product, wherein the ethylene polymer product comprises a first ethylene polymer, a second ethylene polymer. The process utilizes a first reactor and a second reactor where the first and the second reactors may be configured in series or in parallel to one another. A bridged metallocene catalyst formulation produces the first ethylene polymer in the first reactor and a first heterogeneous catalyst formulation produces the second ethylene polymer in the second reactor. In some embodiments, the ethylene polymer product may further include an optional third ethylene polymer produced in a third reactor. The optional third ethylene polymer may be produced employing a second heterogeneous catalyst formulation which may be the same as or different from the first heterogeneous catalyst formulation.

Each of the ethylene polymer product, the ethylene polymer components comprising the ethylene polymer product, and the catalyst formulations employed to produce the ethylene polymer components are further described below.

### Bridged Metallocene Catalyst Formulation

In an embodiment of the disclosure, the bridged metallocene catalyst formulation includes a component A having the Formula (I):

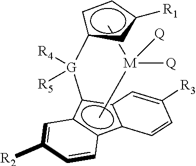

In Formula (I): M is a group 4 metal selected from titanium, zirconium or hafnium; G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In an embodiment, R₄ and R₅ are independently an aryl group.

In an embodiment, R₄ and R₅ are independently a phenyl group or a substituted phenyl group.

In an embodiment, R₄ and R₅ are a phenyl group.

In an embodiment, R₄ and R₅ are independently a substituted phenyl group.

In an embodiment, R₄ and R₅ are a substituted phenyl group, wherein the phenyl group is substituted with a substituted silyl group.

In an embodiment, R₄ and R₅ are a substituted phenyl group, wherein the phenyl group is substituted with a trialkyl silyl group.

In an embodiment, R₄ and R₅ are a substituted phenyl group, wherein the phenyl group is substituted at the para position with a trialkylsilyl group. In an embodiment, R₁ and R₂ are a substituted phenyl group, wherein the phenyl group is substituted at the para position with a trimethylsilyl group. In an embodiment, R₁ and R₂ are a substituted phenyl group, wherein the phenyl group is substituted at the para position with a triethylsilyl group.

In an embodiment, R₄ and R₅ are independently an alkyl group.

In an embodiment, R₄ and R₅ are independently an alkenyl group.

In an embodiment, R₁ is hydrogen.

In an embodiment, R₁ is an alkyl group.

In an embodiment, R₁ is an aryl group.

In an embodiment, R₁ is an alkenyl group.

In an embodiment, R₂ and R₃ are independently a hydrocarbyl group having from 1 to 30 carbon atoms.

In an embodiment, R₂ and R₃ are independently an aryl group.

In an embodiment, R₂ and R₃ are independently an alkyl group.

In an embodiment, R₂ and R₃ are independently an alkyl group having from 1 to 20 carbon atoms.

In an embodiment, R₂ and R₃ are independently a phenyl group or a substituted phenyl group.

In an embodiment, R₂ and R₃ are a tert-butyl group.

In an embodiment, R₂ and R₃ are hydrogen.

In an embodiment, M is hafnium, Hf.

In an embodiment of the disclosure, the bridged metallocene catalyst formulation includes a component A having the Formula (II):

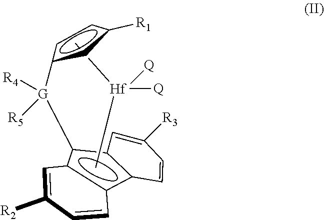

In Formula (II): G is a group 14 element selected from carbon, silicon, germanium, tin or lead; R₁ is a hydrogen atom, a C₁₋₂₀ hydrocarbyl radical, a C₁₋₂₀ alkoxy radical or a C₆₋₁₀ aryl oxide radical; R₂ and R₃ are independently selected from a hydrogen atom, a C₁₋₂₀ hydrocarbyl radical, a C₁₋₂₀ alkoxy radical or a C₆₋₁₀ aryl oxide radical; R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical or a C₆₋₁₀ aryl oxide radical; and Q is independently an activatable leaving group ligand.

In the current disclosure, the term “activatable”, means that the ligand Q may be cleaved from the metal center M via a protonolysis reaction or abstracted from the metal center M by suitable acidic or electrophilic catalyst activator compounds (also known as “co-catalyst” compounds) respectively, examples of which are described below. The activatable ligand Q may also be transformed into another ligand which is cleaved or abstracted from the metal center M (e.g., a halide may be converted to an alkyl group). Without wishing to be bound by any single theory, protonolysis or abstraction reactions generate an active “cationic” metal center which can polymerize olefins.

In embodiments of the present disclosure, the activatable ligand, Q is independently selected from the group consisting of a hydrogen atom; a halogen atom; a C₁₋₂₀ hydrocarbyl radical, a C₁₋₂₀ alkoxy radical, and a C₆₋₁₀ aryl or aryloxy radical, where each of the hydrocarbyl, alkoxy, aryl, or aryl oxide radicals may be un-substituted or further substituted by one or more halogen or other group; a C₁₋₈ alkyl; a C₁₋₈ alkoxy; a C₆₋₁₀ aryl or aryloxy; an amido or a phosphido radical, but where Q is not a cyclopentadienyl. Two Q ligands may also be joined to one another and form for example, a substituted or unsubstituted diene ligand (e.g., 1,3-butadiene); or a delocalized heteroatom containing group such as an acetate or acetamidinate group. In a convenient embodiment of the disclosure, each Q is independently selected from the group consisting of a halide atom, a C₁₋₄ alkyl radical and a benzyl radical. Particularly suitable activatable ligands Q are monoanionic such as a halide (e.g., chloride) or a hydrocarbyl (e.g., methyl, benzyl).

In an embodiment of the disclosure, the component A is diphenylmethylene (cyclopentadienyl) (2,7-di-t-butylfluorenyl) hafnium dichloride having the molecular formula: [(2,7-tBu₂Flu)Ph₂C(Cp)HfCl₂].

In an embodiment of the disclosure the component A is diphenylmethylene (cyclopentadienyl) (2,7-di-t-butylfluorenyl) hafnium dimethyl having the molecular formula: [(2,7-tBu₂Flu)Ph₂C(Cp)HfMe₂].

In addition to the bridged metallocene catalyst molecule per se (component A as defined herein above), a bridged metallocene catalyst formulation may further comprise one or more of the following: an alkylaluminoxane co-catalyst (a component M) and a boron ionic activator (a component B). The homogenous catalyst system may also optionally comprise a hindered phenol (component P).

Although the exact structure of alkylaluminoxane is uncertain, subject matter experts generally agree that it is an oligomeric species that contain repeating units of the general formula:

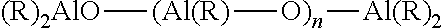

where the R groups may be the same or different linear, branched or cyclic hydrocarbyl radicals containing 1 to 20 carbon atoms and n is from 0 to about 50. A non-limiting example of an alkylaluminoxane is methylaluminoxane (or MAO) wherein each R group is a methyl radical.

In an embodiment of the disclosure, R of the alkylaluminoxane, is a methyl radical and m is from to 40.

10 In an embodiment of the disclosure, the co-catalyst is modified methylaluminoxane (MMAO).

It is well known in the art, that the alkylaluminoxane can serve dual roles as both an alkylator and an activator. Hence, an alkylaluminoxane co-catalyst is often used in combination with activatable ligands such as halogens.

In general, boron ionic activators are comprised of a cation and a bulky anion; wherein the latter is substantially non-coordinating. Non-limiting examples of boron ionic activators are boron ionic activators that are four coordinate with four ligands bonded to the boron atom. Non-limiting examples of boron ionic activators include the following formulas shown below:

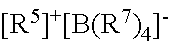

where B represents a boron atom, R⁵ is an aromatic hydrocarbyl (e.g., triphenyl methyl cation) and each R⁷ is independently selected from phenyl radicals which are unsubstituted or substituted with from 3 to 5 substituents selected from fluorine atoms, C₁₋₄ alkyl or alkoxy radicals which are unsubstituted or substituted by fluorine atoms; and a silyl radical of formula-Si(R⁹)₃, where each R⁹ is independently selected from hydrogen atoms and C₁₋₄ alkyl radicals, and

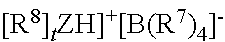

where B is a boron atom, H is a hydrogen atom, Z is a nitrogen or phosphorus atom, t is 2 or 3 and R⁸ is selected from C₁₋₈ alkyl radicals, phenyl radicals which are unsubstituted or substituted by up to three C₁₋₄ alkyl radicals, or one R⁸ taken together with the nitrogen atom may form an anilinium radical and R⁷ is as defined above.

In both formula, a non-limiting example of R⁷ is a pentafluorophenyl radical. In general, boron ionic activators may be described as salts of tetra(perfluorophenyl) boron; non-limiting examples include anilinium, carbonium, oxonium, phosphonium and sulfonium salts of tetra(perfluorophenyl) boron with anilinium and trityl (or triphenylmethylium). Additional non-limiting examples of boron ionic activators include: triethylammonium tetra(phenyl) boron, tripropylammonium tetra(phenyl) boron, tri (n-butyl) ammonium tetra(phenyl) boron, trimethylammonium tetra(p-tolyl) boron, trimethylammonium tetra(o-tolyl) boron, tributylammonium tetra(pentafluorophenyl) boron, tripropylammonium tetra(o,p-dimethylphenyl) boron, tributylammonium tetra(m,m-dimethylphenyl) boron, tributylammonium tetra(p-trifluoromethylphenyl) boron, tributylammonium tetra(pentafluorophenyl) boron, tri (n-butyl) ammonium tetra(o-tolyl) boron, N,N-dimethylanilinium tetra(phenyl) boron, N,N-diethylanilinium tetra(phenyl) boron, N,N-diethylanilinium tetra(phenyl)n-butylboron, N,N-2,4,6-pentamethylanilinium tetra(phenyl) boron, di-(isopropyl) ammonium tetra(pentafluorophenyl) boron, dicyclohexylammonium tetra(phenyl) boron, triphenylphosphonium tetra(phenyl) boron, tri(methylphenyl)phosphonium tetra(phenyl) boron, tri (dimethylphenyl)phosphonium tetra(phenyl) boron, tropillium tetrakispentafluorophenyl borate, triphenylmethylium tetrakispentafluorophenyl borate, benzene (diazonium)tetrakispentafluorophenyl borate, tropillium tetrakis(2,3,5,6-tetrafluorophenyl) borate, triphenylmethylium tetrakis(2,3,5,6-tetrafluorophenyl) borate, benzene (diazonium)tetrakis(3,4,5-trifluorophenyl) borate, tropillium tetrakis(3,4,5-trifluorophenyl) borate, benzene (diazonium)tetrakis(3,4,5-trifluorophenyl) borate, tropillium tetrakis(1,2,2-trifluoroethenyl) borate, triphenylmethylium tetrakis(1,2,2-trifluoroethenyl) borate, benzene (diazonium)tetrakis(1,2,2-trifluoroethenyl) borate, tropillium tetrakis(2,3,4,5-tetrafluorophenyl) borate, triphenylmethylium tetrakis(2,3,4,5-tetrafluorophenyl) borate, and benzene (diazonium)tetrakis (2,3,4,5 tetrafluorophenyl) borate. Readily available commercial boron ionic activators include N,N-dimethylanilinium tetrakispentafluorophenyl borate, and triphenylmethylium tetrakispentafluorophenyl borate.

Non-limiting example of hindered phenols include butylated phenolic antioxidants, butylated hydroxytoluene, 2,6-di-tertiarybutyl-4-ethyl phenol, 4,4′-methylenebis(2,6-di-tertiary-butylphenol), 1,3,5-trimethyl-2,4,6-tris(3,5-di-tert-butyl-4-hydroxybenzyl)benzene and octadecyl-3-(3′,5′-di-tert-butyl-4′-hydroxyphenyl) propionate.

To produce an active bridged metallocene catalyst formulation the quantity and mole ratios of the three or four components: component A, component M, component B, and the optional component P are optimized.

### First and Second Heterogeneous Catalyst Formulations

Suitable first and second heterogenous catalyst formulations include a number of heterogeneous catalyst formulations well known to those skilled in the art. Non-limiting examples include Ziegler-Natta and chromium catalyst formulations.

In this disclosure, embodiments include an inline Ziegler-Natta catalyst formulation. The term “inline Ziegler-Natta catalyst formulation” refers to the continuous synthesis of a small quantity of active Ziegler-Natta catalyst and immediately injecting this catalyst into at least one continuously operating reactor, wherein the catalyst polymerizes ethylene and one or more optional α-olefins to form an ethylene polymer in that reactor—e.g., to form a second ethylene polymer in a second reactor or an optional third ethylene polymer in a third reactor.

A wide variety of chemical compounds can be used to synthesize an active Ziegler-Natta catalyst formulation. The following describes various chemical compounds that may be combined to produce an active Ziegler-Natta catalyst formulation. Those skilled in the art will understand that the embodiments in this disclosure are not limited to the specific chemical compound disclosed.

An active Ziegler-Natta catalyst formulation may be formed from: a magnesium compound, a chloride compound, a metal compound, an alkyl aluminum co-catalyst and an aluminum alkyl. In the present disclosure “(v)” refers to “component (v)” the magnesium compound; the term “(vi)” refers to the “component (vi)” the chloride compound; “(vii)” refers to “component (vii)” the metal compound; “(viii)” refers to “component (viii)” alkyl aluminum co-catalyst, and; “(ix)” refers to “component (ix)” the aluminum alkyl. As will be appreciated by those skilled in the art, Ziegler-Natta catalyst formulations may contain additional components; a non-limiting example of an additional component is an electron donor, e.g., amines or ethers.

A non-limiting example of an active inline Ziegler-Natta catalyst formulation can be prepared as follows. In the first step, a solution of a magnesium compound, component (v), is reacted with a solution of the chloride compound, component (vi), to form a magnesium chloride support suspended in solution. Non-limiting examples of magnesium compounds include Mg(R¹)₂; wherein the R¹ groups may be the same or different, linear, branched or cyclic hydrocarbyl radicals containing 1 to 10 carbon atoms. Non-limiting examples of chloride compounds include R²Cl; wherein R² represents a hydrogen atom, or a linear, branched or cyclic hydrocarbyl radical containing 1 to 10 carbon atoms. In the first step, the solution of magnesium compound may also contain an aluminum alkyl, component (ix). Non-limiting examples of aluminum alkyl include Al(R³)₃, wherein the R³ groups may be the same or different, linear, branched or cyclic hydrocarbyl radicals containing from 1 to 10 carbon atoms. In the second step a solution of the metal compound, component (vii), is added to the solution of magnesium chloride and the metal compound is supported on the magnesium chloride. Non-limiting examples of suitable metal compounds include M*(X)ₙ or M*O(X)ₙ; where M* represents a metal selected from Group 4 through Group 8 of the Periodic Table, or mixtures of metals selected from Group 4 through Group 8; O represents oxygen, and; X represents chloride or bromide; n is an integer from 3 to 6 that satisfies the oxidation state of the metal. Additional non-limiting examples of suitable metal compounds include Group 4 to Group 8 metal alkyls, metal alkoxides (which may be prepared by reacting a metal alkyl with an alcohol) and mixed-ligand metal compounds that contain a mixture of halide, alkyl and alkoxide ligands. In the third step a solution of an alkyl aluminum co-catalyst, component (viii), is added to the metal compound supported on the magnesium chloride. A wide variety of alkyl aluminum co-catalysts are suitable, as expressed by Formula (C):

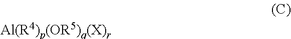

wherein the R⁴ groups may be the same or different, hydrocarbyl groups having from 1 to 10 carbon atoms; the OR⁵ groups may be the same or different, alkoxy or aryloxy groups wherein R⁵ is a hydrocarbyl group having from 1 to 10 carbon atoms bonded to oxygen; X is chloride or bromide, and; (p+q+r)=3, with the proviso that p is greater than 0. Non-limiting examples of commonly used alkyl aluminum co-catalysts include trimethyl aluminum, triethyl aluminum, tributyl aluminum, dimethyl aluminum methoxide, diethyl aluminum ethoxide, dibutyl aluminum butoxide, dimethyl aluminum chloride or bromide, diethyl aluminum chloride or bromide, dibutyl aluminum chloride or bromide and ethyl aluminum dichloride or dibromide.

The process described in the paragraph above, to synthesize an active inline Ziegler-Natta catalyst formulation, can be carried out in a variety of solvents; non-limiting examples of solvents include linear or branched C₅ to C₁₂ alkanes or mixtures thereof. To produce an active inline Ziegler-Natta catalyst formulation the quantity and mole ratios of the five components, (v) through (ix), are optimized.

Additional embodiments of heterogeneous catalyst formulations include formulations where the “metal compound” is a chromium compound; non-limiting examples include silyl chromate, chromium oxide and chromocene. In some embodiments, the chromium compound is supported on a metal oxide such as silica or alumina. Heterogeneous catalyst formulations containing chromium may also include co-catalysts; non-limiting examples of co-catalysts include trialkylaluminum, alkylaluminoxane and dialkoxyalkylaluminum compounds and the like.

### Solution-Phase Polymerization Process

Embodiments of the present disclosure include a continuous solution-phase polymerization process that produces ethylene polymer products wherein said ethylene polymer products comprise a first ethylene polymer and a second ethylene polymer.

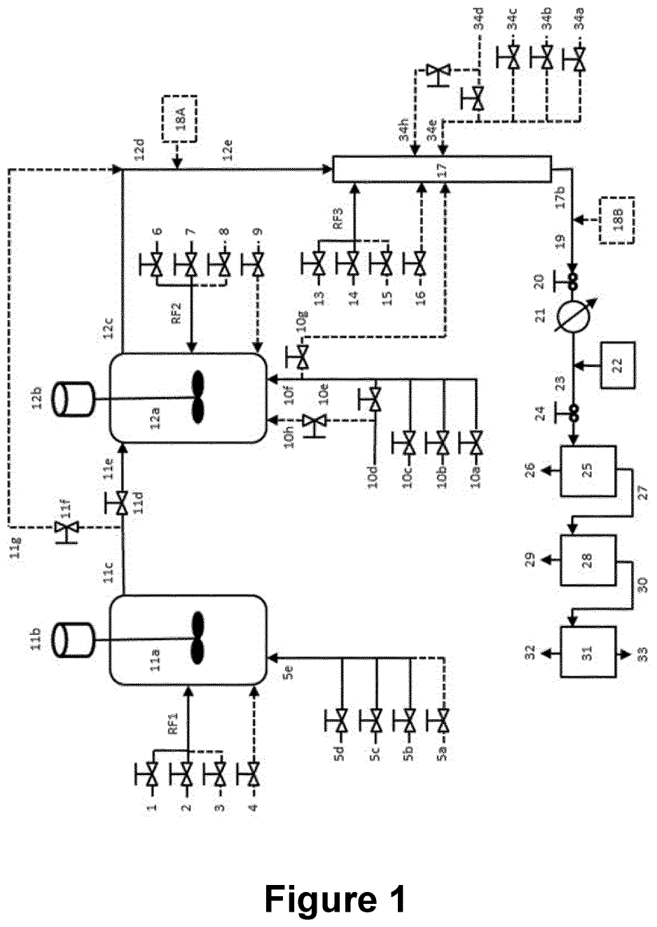

In an embodiment of the continuous solution-phase polymerization process, process solvent, monomer(s) and a catalyst formulation are continuously fed to a reactor where the ethylene polymer is formed in solution. In FIG. 1, process solvent (1), ethylene (2) and optional α-olefin (3) are combined to produce a first feed stream (RF1) which flows into the first reactor (11a). In FIG. 1, optional streams, or optional embodiments, are denoted with dotted lines.

In the present disclosure, it is not particularly important that the combined first feed stream (RF1) be formed. In an embodiment of the disclosure, streams (1) through (3) are independently injected into reactor (11a).

Optionally, hydrogen may be injected into reactor (11a) through stream (104). Hydrogen is generally added to control the molecular weight of the first ethylene polymer produced in reactor (11a). Reactor (11a) is continuously stirred by stirring assembly (11b) which includes a motor external to the reactor and an agitator within the reactor. In the art, such a reactor is frequently called a CSTR (continuously stirred tank reactor).

A bridged metallocene catalyst formulation is injected into reactor (11a) through stream (5e). The bridged metallocene catalyst formulation component streams 5d, 5c, 5b and optional 5a refer to the ionic activator, component B, the bulky ligand-metal complex, component A, the alumoxane co-catalyst, component M, and optional hindered phenol, component P, respectively. Bridged metallocene catalyst formulation component streams can be arranged in all possible configurations, including an embodiment where streams 5d through 5a are independently injected into first reactor (11a). Each bridged metallocene catalyst formulation component is dissolved in a catalyst component solvent. Catalyst component solvents, for component A, and components M, B, and P may be the same or different. Catalyst component solvents are selected such that the combination of catalyst components does not produce a precipitate in any process stream; for example, precipitation of a bridged metallocene catalyst component in stream 5e. The optimization of the bridged metallocene catalyst formulation is described below.

First reactor (11a) produces a first exit stream, stream (11c), containing the first ethylene polymer dissolved in process solvent, as well as unreacted ethylene, unreacted α-olefins (if present), unreacted hydrogen (if present), active bridged metallocene catalyst, deactivated bridged metallocene catalyst, residual catalyst components and other impurities (if present). Melt index ranges and density ranges of the first ethylene polymer produced are described below under the First Ethylene Polymer section.

The continuous solution-phase polymerization process shown in FIG. 1 includes two embodiments where reactors (11a) and (12a) can be operated in series or parallel modes. In series mode 100% of stream (11c), i.e., the first exit stream, passes through flow controller (11d) forming stream (11e) which enters second reactor (12a). In contrast, in parallel mode 100% of stream (11c) passes through flow controller (11f) forming stream (11g). Stream (11g) by-passes reactor (12a) and is combined with stream (12c), i.e., the second exit stream, forming stream (12d), i.e., the third exit stream.

Reactor feed streams are injected into reactor (12a); process solvent (6), ethylene (7) and optional α-olefin (8) are combined to produce reactor feed stream (RF2). In the present disclosure, for the reasons detailed below, it is specifically important that stream (RF2) is formed; i.e., reactor feed streams (6) through (8) are combined. Optionally hydrogen may be injected into reactor (12a) through stream (9) to control the molecular weight of the second ethylene polymer produced in the second reactor (12a). In an alternative embodiment, stream (9) is combined with process solvent (6), ethylene (7) and optional α-olefin (8) are combined to produce reactor feed stream (RF2*), not shown in FIG. 1. Reactor (12a) is continuously stirred by stirring assembly (12b) which includes a motor external to the reactor and an agitator within the reactor.

A first inline heterogeneous catalyst formulation is injected into reactor (12a) through stream (10f), and a second ethylene polymer is formed in reactor (12a). The components that comprise the first inline heterogeneous catalyst formulation are introduced through streams (10a), (10b), (10c) and (10d). A first multistage heterogeneous catalyst assembly, defined by the conduits and flow controllers associated with streams (10a)-(10h), is operated as described below. In the case of a Ziegler-Natta catalyst, the first heterogeneous catalyst assembly produces an efficient first inline Ziegler-Natta catalyst formulation by optimizing the following molar ratios: (aluminum alkyl)/(magnesium compound) or (ix)/(v); (chloride compound)/(magnesium compound) or (vi)/(v); (alkyl aluminum co-catalyst)/(metal compound) or (viii)/(vii), and; (aluminum alkyl)/(metal compound) or (ix)/(vii); as well as the time these compounds have to react and equilibrate.

Stream (10a), stream S1, contains a binary blend of a magnesium compound, component (v), and an aluminum alkyl, component (ix), in process solvent. The upper limit on the (aluminum alkyl)/(magnesium compound) molar ratio in stream (10a) may be about 70, in some cases about 50 and is other cases about 30. The lower limit on the (aluminum alkyl)/(magnesium compound) molar ratio may be about 3.0, in some cases about 5.0 and in other cases about 10. Stream (10b), stream S2, contains a solution of a chloride compound, component (vi), in process solvent. In a first stage, stream (10b) is combined with stream (10a) and the intermixing of streams (10a) and (10b) produces a magnesium chloride catalyst support. To produce an efficient first inline Ziegler-Natta catalyst (efficient in olefin polymerization), the (chloride compound)/(magnesium compound) molar ratio is optimized. The upper limit on the (chloride compound)/(magnesium compound) molar ratio may be about 4, in some cases about 3.5 and is other cases about 3.0. The lower limit on the (chloride compound)/(magnesium compound) molar ratio may be about 1.0, in some cases about 1.5 and in other cases about 1.9. The time between the addition of the chloride compound and the addition of the metal compound, component (vii), in a second stage, via stream (10c), stream S3, is controlled; hereafter HUT-1 (the first hold-up-time). HUT-1 is the time for streams (10a), stream S1, and (10b), stream S2, to equilibrate and form a magnesium chloride support. The upper limit on HUT-1 may be about 70 seconds, in some cases about 60 seconds and is other cases about 50 seconds. The lower limit on HUT-1 may be about 5 seconds, in some cases about 10 seconds and in other cases about 20 seconds. HUT-1 is controlled by adjusting the length of the conduit between stream 10b injection port and stream (10c) injection port, as well as controlling the flow rates of streams (10a) and (10b). The time between the addition of component (vii) and the addition of the alkyl aluminum co-catalyst, component (viii), in a third stage, via stream (10d), stream S4, is controlled; hereafter HUT-2 (the second hold-up-time). HUT-2 is the time for the magnesium chloride support and stream 10c to react and equilibrate. The upper limit on HUT-2 may be about 50 seconds, in some cases about 35 seconds and is other cases about 25 seconds. The lower limit on HUT-2 may be about 2 seconds, in some cases about 6 seconds and in other cases about 10 seconds. HUT-2 is controlled by adjusting the length of the conduit between stream (10c) injection port and stream (10d) injection port, as well as controlling the flow rates of streams (10a), (10b) and (10c). The quantity of the alkyl aluminum co-catalyst added is optimized to produce an efficient catalyst; this is accomplished by adjusting the (alkyl aluminum co-catalyst)/(metal compound) molar ratio, or (viii)/(vii) molar ratio. The upper limit on the (alkyl aluminum co-catalyst)/(metal compound) molar ratio may be about 10, in some cases about 7.5 and is other cases about 6.0. The lower limit on the (alkyl aluminum co-catalyst)/(metal compound) molar ratio may be 0, in some cases about 1.0 and in other cases about 2.0. In addition, the time between the addition of the alkyl aluminum co-catalyst (stream S4) and the injection of the inline Ziegler-Natta catalyst formulation into reactor (12a) is controlled; hereafter HUT-3 (the third hold-up-time). HUT-3 is the time for stream (10d) to intermix and equilibrate to form the inline Ziegler Natta catalyst formulation. The upper limit on HUT-3 may be about 15 seconds, in some cases about 10 seconds and is other cases about 8 seconds. The lower limit on HUT-3 may be about 0.5 seconds, in some cases about 1 seconds and in other cases about 2 seconds. HUT-3 is controlled by adjusting the length of the conduit between stream (10d) injection port and the catalyst injection port in reactor (12a), and by controlling the flow rates of streams (10a) through (10d). As shown in FIG. 1, optionally, 100% of stream (10d), the alkyl aluminum co-catalyst, may be injected directly into reactor (12a) via stream (10h) and the second product mixture is equilibrated for an additional HUT-3 seconds in a third stage of the first heterogeneous catalyst assembly prior to injection into reactor (12a) vis stream (10f). Optionally, a portion of stream (10d) may be injected directly into reactor (12a) via stream (10h) and the remaining portion of stream (10d) injected into reactor (12a) via stream (10f).

An equivalent term for reactor (12a) is “R2”. The quantity of the first inline heterogeneous catalyst formulation added to R2 is expressed as the parts-per-million (ppm) of metal compound, component (vii), in the reactor solution, hereafter “R2 (vii) (ppm)”. The upper limit on R2 (vii) (ppm) may be about 10 ppm, in some cases about 8 ppm and in other cases about 6 ppm. The lower limit on R2 (vii) (ppm) in some cases may be about 0.5 ppm, in other cases about 1 ppm and in still other cases about 2 ppm. The (aluminum alkyl)/(metal compound) molar ratio in reactor (12a), or the (ix)/(vii) molar ratio, is also controlled. The upper limit on the (aluminum alkyl)/(metal compound) molar ratio in the reactor may be about 2, in some cases about 1.5 and is other cases about 1.0. The lower limit on the (aluminum alkyl)/(metal compound) molar ratio may be about 0.05, in some cases about 0.075 and in other cases about 0.1.

Any combination of the streams employed to prepare and deliver the inline heterogeneous catalyst formulation to R2 may be heated or cooled, i.e., streams (10a) through (10h), including stream (10g), optional R3 delivery, which is discussed below. In some cases the upper temperature limit of streams (10a) through (10g) may be about 90° C., in other cases about 80° C. and in still other cases about 70° C. and; in some cases the lower temperature limit may be about 20° C.; in other cases about 35° C. and in still other cases about 50° C. The flow rate through process streams (10f) or (5e) can vary over a wide range, e.g., depending on catalyst activity and reactor volume. In this disclosure, the flow rate through process stream (10f) is expressed as a percent of the total amount of process solvent exiting (R2): the upper limit on the flow rate through process stream (10f) may be about (20%), in other cases about (15%) and in still other cases about (10%) of the total amount of process solvent exiting R2; the lower limit on the flow rate through process stream (10f) may be about 0.01%, in other cases about 0.05% and in still other cases about 0.1% of the total process solvent exiting R2.

Injection of the inline heterogeneous catalyst formulation into reactor (12a) produces a second ethylene polymer and a second exit stream (12c).

If reactors (11a) and (12a) are operated in a series mode, the second exit stream (12c) contains the second ethylene polymer and the first ethylene polymer dissolved in process solvent; as well as unreacted ethylene, unreacted α-olefins (if present), unreacted hydrogen (if present), active catalysts, deactivated catalysts, catalyst components and other impurities (if present). Optionally the second exit stream (12c) is deactivated by adding a catalyst deactivator A from catalyst deactivator tank (18A) forming a deactivated solution A, stream (12e); in this case, FIG. 1 defaults to a dual reactor solution process. If the second exit stream (12c) is not deactivated the second exit stream enters tubular reactor (17). Catalyst deactivator A is discussed below.

If reactors (11a) and (12a) are operated in parallel mode, the second exit stream (12c) contains the second ethylene polymer dissolved in process solvent. The second exit stream (12c) is combined with stream (11g) forming a third exit stream (12d), the latter contains the second ethylene polymer and the first ethylene polymer dissolved in process solvent; as well as unreacted ethylene, unreacted α-olefins (if present), unreacted hydrogen (if present), active catalyst, deactivated catalyst, catalyst components and other impurities (if present). Optionally the third exit stream (12d) is deactivated by adding catalyst deactivator A from catalyst deactivator tank (18A) forming deactivated solution A, stream (12e); in this case, FIG. 1 defaults to a dual reactor solution process. If the third exit stream (12d) is not deactivated the third exit stream (12d) enters tubular reactor (17).

The term “tubular reactor” is meant to convey its conventional meaning, namely a simple tube; wherein the length/diameter (L/D) ratio is at least 10/1. Optionally, one or more of the following reactor feed streams may be injected into tubular reactor (17); process solvent (13), ethylene (14) and optional α-olefin (15). As shown in FIG. 1, streams (13), (14) and (15) may be combined forming reactor feed stream (RF3) and the latter is injected into reactor (17). In the present disclosure, it is not particularly important that fresh feed stream RF3 be formed; i.e., reactor feed streams can be combined in all possible combinations. Optionally hydrogen may be injected into reactor (17) through stream (16). Optionally, the first inline heterogeneous catalyst formulation may be injected into reactor (17) via catalyst stream (10g); i.e., a portion of the inline heterogeneous catalyst enters reactor (12a) through stream (10f) and the remaining portion of the inline heterogeneous catalyst enters reactor (17) through stream (10g).

FIG. 1 shows an additional embodiment where reactor (17) is supplied with a second heterogeneous catalyst formulation produced in a second heterogeneous catalyst assembly. The second heterogeneous catalyst assembly refers to the combination of conduits and flow controllers that include streams (34a)-(34e) and (34h). The chemical composition of the first and second heterogeneous catalyst formulations may be the same, or different. In the case of a Ziegler-Natta catalyst, the second heterogeneous catalyst assembly produces a second inline Ziegler-Natta catalyst formulation. For example, the catalyst components (v) through (ix), mole ratios and hold-up-times may differ in the first and second heterogeneous catalyst assemblies. Relative to the first heterogeneous catalyst assembly, the second heterogeneous catalyst assembly is operated in a similar manner, i.e., the second heterogeneous catalyst assembly generates an efficient catalyst by optimizing hold-up-times and the following molar ratios: (aluminum alkyl)/(magnesium compound), (chloride compound)/(magnesium compound), (alkyl aluminum co-catalyst/(metal compound, and (aluminum alkyl)/(metal compound). To be clear: stream 34a contains a binary blend of magnesium compound, component (v), and aluminum alkyl, component (ix), in process solvent; stream (34b) contains a chloride compound, component (vi), in process solvent; stream (34c) contains a metal compound, component (vii), in process solvent, and; stream (34d) contains an alkyl aluminum co-catalyst, component (viii), in process solvent. Once prepared, the inline Ziegler-Natta catalyst is injected into reactor (17) through stream (34e); optionally, additional alkyl aluminum co-catalyst is injected into reactor (17) through stream (34h). As shown in FIG. 1, optionally, 100% of stream (34d), the alkyl aluminum co-catalyst, may be injected directly into reactor (17) via stream (34h). Optionally, a portion of stream (34d) may be injected directly into reactor (17) via stream (34h) and the remaining portion of stream (34d) injected into reactor (17) via stream (34e). In FIG. 1, the first or the second heterogeneous catalyst assembly supplies 100% of the catalyst to reactor (17). Any combination of the streams that comprise the second heterogeneous catalyst assembly may be heated or cooled, i.e., streams (34a)-(34e) and (34h); in some cases the upper temperature limit of streams (34a)-(34e) and (34h) may be about 90° C., in other cases about 80° C. and in still other cases about 70° C. and; in some cases the lower temperature limit may be about 20° C.; in other cases about 35° C. and in still other cases about 50° C. The flow rate through process stream (34e) can vary over a wide range, e.g., depending on catalyst activity and reactor volume. In this disclosure, the flow rate through process stream (34e) is expressed as a percent of the total amount of process solvent exiting R3: the upper limit on the flow rate through process stream (34e) may be about 20%, in other cases about 15% and in still other cases about 10% of the total amount of process solvent exiting R3; the lower limit on the flow rate through process stream 34e may be about 0.01%, in other cases about 0.05% and in still other cases about 0.1% of the total process solvent exiting R3.

In reactor (17), a third ethylene polymer may, or may not, form. The optional third ethylene polymer will not form if catalyst deactivator A is added upstream of reactor (17) via catalyst deactivator tank (18A). A third ethylene polymer will be formed if catalyst deactivator B is added downstream of reactor (17) via catalyst deactivator tank (18B).

The optional third ethylene polymer produced in reactor (17) may be formed using a variety of operational modes; with the proviso that catalyst deactivator A is not added upstream of reactor (17). Non-limiting examples of operational modes include: (a) residual ethylene, residual optional α-olefin and residual active catalyst entering reactor (17) react to form the optional third ethylene polymer, or; (b) fresh process solvent (13), fresh ethylene (14) and optionally fresh α-olefin (15) are added to reactor (17) and the residual active catalyst entering reactor (17) forms the optional third ethylene polymer, or; (c) the fresh second inline heterogeneous catalyst formulation is added to reactor (17) via stream (10g) or stream (34e) to polymerize residual ethylene and residual optional «-olefin to form the optional third ethylene polymer, or; (d) fresh process solvent (13), ethylene (14), optional «-olefin (15) and fresh second inline heterogeneous catalyst formulation, (10g) or (34e), are added to reactor (17) to form the optional third ethylene polymer. Optionally, 100% of the alkyl aluminum co-catalyst may be added to reactor (17) via stream (34h), or a portion of the alkyl aluminum co-catalyst may be added to reactor (17) via stream (10g) or (34h) and the remaining portion added via stream (34e). Optionally fresh hydrogen (16) may be added to reduce the molecular weight of the optional third optional ethylene polymer.

In series mode, reactor (17) produces a third exit stream (17b) containing the first ethylene polymer, the second ethylene polymer and optionally a third ethylene polymer. As shown in FIG. 1, catalyst deactivator B may be added to the third exit stream (17b) via catalyst deactivator tank (18B) producing a deactivated solution B, stream (19); with the proviso that catalyst deactivator B is not added if catalyst deactivator A was added upstream of reactor (17). Deactivated solution B may also contain unreacted ethylene, unreacted optional «-olefin, unreacted optional hydrogen and impurities if present. As indicated above, if catalyst deactivator A was added, deactivated solution A, stream (12e), exits tubular reactor (17) as shown in FIG. 1.

In parallel mode operation, reactor (17) produces a fourth exit stream (17b) containing the first ethylene polymer, the second ethylene polymer and optionally a third ethylene polymer. As indicated above, in parallel mode, stream (12d) is the third exit stream. As shown in FIG. 1, in parallel mode, catalyst deactivator B is added to the fourth exit stream (17b) via catalyst deactivator tank 18B producing a deactivated solution B, stream 19; with the proviso that catalyst deactivator B is not added if catalyst deactivator A was added upstream of reactor 17.

In FIG. 1, deactivated solution A, stream (12e), or B stream (19) passes through pressure let down device (20), heat exchanger (21) and a passivator is added via tank (22) forming a passivated solution (23); the passivator is described below. The passivated solution passes through pressure let down device (24) and enters a first vapor/liquid separator (25). Hereafter, “V/L” is equivalent to vapor/liquid. Two streams are formed in the first V/L separator: a first bottom stream (27) comprising a solution that is rich in ethylene polymers and also contains residual ethylene, residual optional «-olefins and catalyst residues, and; a first gaseous overhead stream (26) comprising ethylene, process solvent, optional α-olefins, optional hydrogen, oligomers and light-end impurities if present.

The first bottom stream enters a second V/L separator (28). In the second V/L separator two streams are formed: a second bottom stream (30) comprising a solution that is richer in ethylene polymer and leaner in process solvent relative to the first bottom stream (27), and; a second gaseous overhead stream (29) comprising process solvent, optional α-olefins, ethylene, oligomers and light-end impurities if present.

The second bottom stream (30) flows into a third V/L separator (31). In the third V/L separator two streams are formed: a product stream (33) comprising an ethylene polymer product, deactivated catalyst residues and less than 5 weight % of residual process solvent, and; a third gaseous overhead stream (32) comprised essentially of process solvent, optional α-olefins and light-end impurities if present.

Product stream (33) proceeds to polymer recovery operations. Non-limiting examples of polymer recovery operations include one or more gear pump, single screw extruder or twin-screw extruder that forces the molten ethylene polymer product through a pelletizer. A devolatilizing extruder may be used to remove small amounts of residual process solvent and optional α-olefin, if present. Once pelletized the solidified ethylene polymer product is typically dried and transported to a product silo.

The first, second and third gaseous overhead streams shown in FIG. 1—streams (26), (29) and (32), respectively—are sent to a distillation column where solvent, ethylene and optional α-olefin are separated for recycling, or; the first, second and third gaseous overhead streams are recycled to the reactors, or; a portion of the first, second and third gaseous overhead streams are recycled to the reactors and the remaining portion is sent to a distillation column.

In the continuous solution-phase polymerization process embodiments shown in FIG. 1 that produce an ethylene polymer product, a variety of solvents may be used as the process solvent; non-limiting examples include linear, branched or cyclic C₅ to C₁₂ alkanes. Non-limiting examples of α-olefins include 1-propene, 1-butene, 1-pentene, 1-hexene and 1-octene. Suitable catalyst component solvents include aliphatic and aromatic hydrocarbons. Non-limiting examples of aliphatic catalyst component solvents include linear, branched or cyclic C₅₋₁₂ aliphatic hydrocarbons, e.g., pentane, methyl pentane, hexane, heptane, octane, cyclohexane, methylcyclohexane, hydrogenated naphtha or combinations thereof. Non-limiting examples of aromatic catalyst component solvents include benzene, toluene (methylbenzene), ethylbenzene, o-xylene (1,2-dimethylbenzene), m-xylene (1,3-dimethylbenzene), p-xylene (1,4-dimethylbenzene), mixtures of xylene isomers, hemellitene (1,2,3-trimethylbenzene), pseudocumene (1,2,4-trimethylbenzene), mesitylene (1,3,5-trimethylbenzene), mixtures of trimethylbenzene isomers, prehenitene (1,2,3,4-tetramethylbenzene), durene (1,2,3,5-tetramethylbenzene), mixtures of tetramethylbenzene isomers, pentamethylbenzene, hexamethylbenzene and combinations thereof.

It is well known to individuals experienced in the art that reactor feed streams (solvent, monomer, α-olefin, hydrogen, catalyst formulation etc.) must be essentially free of catalyst deactivating poisons; non-limiting examples of poisons include trace amounts of oxygenates such as water, fatty acids, alcohols, ketones and aldehydes. Such poisons are removed from reactor feed streams using standard purification practices; non-limiting examples include molecular sieve beds, alumina beds and oxygen removal catalysts for the purification of solvents, ethylene and α-olefins, etc.

Referring to the first reactor in FIG. 1, any combination of the fresh feed streams to the first reactor (11a) may be heated or cooled: more specifically, streams (1)-(4). The upper limit on the first reactor fresh feed streams (1) through (4) temperatures may be about 90° C.; in other cases about 80° C. and in still other cases about 70° C. The lower limit on reactor feed stream temperatures may be about 0° C.; in other cases about 10° C. and in still other cases about 20° C.

Referring to the second reactor (R₂) in FIG. 1, the fresh feed streams to the second reactor 12a may be heated or cooled: more specifically, streams (6)-(9). The upper limit on the second reactor fresh feed streams (6) through (9) temperatures may be about 90° C.; in other cases, about 85° C. and in still other cases about 80° C. The lower limit on second reactor feed streams (6) through (9) temperatures may be about 60° C.; in other cases, about 65° C. and in still other cases about 70° C. In some cases, the combined fresh feed streams RF2 or RF2* has a temperature T_{f} of greater than or equal to 60° C. and less than or equal to 90° C., or of greater than or equal to 60° C. and less than or equal to 85° C., or of greater than or equal to 60° C. and less than or equal to 80° C.

Any combination of the streams feeding the tubular reactor may be heated or cooled; specifically, streams (13)-(16) in FIG. 1. In some cases, tubular reactor feed streams are tempered, i.e., the tubular reactor feed streams are heated to at least above ambient temperature. The upper temperature limit on the tubular reactor feed streams in some cases is about 200° C., in other cases about 170° C. and in still other cases about 140° C.; the lower temperature limit on the tubular reactor feed streams in some cases is about 60° C., in other cases about 90° C. and in still other cases about 120° C.; with the proviso that the temperature of the tubular reactor feed streams are lower than the temperature of the process stream that enters the tubular reactor.

In the embodiments shown in FIG. 1 the exit temperatures of the solution polymerization reactors, vessels (11a), R1, and (12a), R2, can vary over a wide range. For example, the upper limit on temperature of first and second exit temperatures in some cases may be about 300° C., in other cases about 280° C. and in still other cases about 260° C.; and the lower limit in some cases may be about 80° C., in other cases about 100° C. and in still other cases about 125° C. The second exit stream temperature, stream (12c), has a higher temperature than the first exit stream temperature (11c)—i.e., second exit temperature has a second temperature T₂ and first exit temperature has a first temperature T₁ where T₂ and T₁ satisfy the inequality T₂>T₁. The maximum temperature difference between these two exit temperatures (T₂-T₁) in some cases is about 75° C., in other cases about 70° C. and in still other cases about 68° C.; the minimum T₂−T₁ in some cases is about 45° C., in other cases about 48° C. and in still other cases about 50° C.

In some cases, R1 and R2 are operated in an adiabatic fashion.

The third exit stream (in series mode operation) or the fourth exit stream (in parallel mode operation) exiting the tubular reactor, reactor (17), R3, has a temperature T₃ which may be in some cases about 100° C. higher than T₂; in other cases, about 60° C. higher than T₂, in still other cases about 10° C. higher than T₂ and in alternative cases 0° C. higher, i.e., the same temperature as T₂.

The temperature within optional R3 may increase along its length. The maximum temperature difference between the inlet and outlet of R3 in some cases is about 100° C., in other cases about 60° C. and in still other cases about 40° C. The minimum temperature difference between the inlet and outlet of R₃ is in some cases may be 0° C., in other cases about 3° C. and in still other cases about 10° C.

In some cases, R3 is operated in an adiabatic fashion.

The pressure in the polymerization reactors should be high enough to maintain the polymerization solution as a single phase solution and to provide the upstream pressure to force the polymer solution from the reactors through a heat exchanger and on to polymer recovery operations. Referring to the embodiment shown in FIG. 1, the operating pressure of the solution polymerization reactors can vary over a wide range. For example, the upper limit on reactor pressure in some cases may be about 45 MPag, in other cases about 30 MPag and in still other cases about 20 MPag; and the lower limit in some cases may be about 3 MPag, in other some cases about 5 MPag and in still other cases about 7 MPag.

Referring to the embodiment shown in FIG. 1, prior to entering the first V/L separator, the passivated solution (stream 23) may have a maximum temperature in some cases of about 300° C., in other cases about 290° C. and in still other cases about 280° C.; the minimum temperature may be in some cases about 150° C., in other cases about 200° C. and in still other cases about 220° C. Immediately prior to entering the first V/L separator the passivated solution in some cases may have a maximum pressure of about 40 MPag, in other cases about 25 MPag and in still cases about 15 MPag; the minimum pressure in some cases may be about 1.5 MPag, in other cases about 5 MPag and in still other cases about 6 MPag.

The first V/L separator (vessel 25 in FIG. 1) may be operated over a relatively broad range of temperatures and pressures. For example, the maximum operating temperature of the first V/L separator in some cases may be about 300° C., in other cases about 285° C. and in still other cases about 270° C.; the minimum operating temperature in some cases may be about 100° C., in other cases about 140° C. and in still other cases 170° C. The maximum operating pressure of the first V/L separator in some cases may be about 20 MPag, in other cases about 10 MPag and in still other cases about 5 MPag; the minimum operating pressure in some cases may be about 1 MPag, in other cases about 2 MPag and in still other cases about 3 MPag.

The second V/L separator, vessel (28) in FIG. 1, may be operated over a relatively broad range of temperatures and pressures. For example, the maximum operating temperature of the second V/L separator in some cases may be about 300° C., in other cases about 250° C. and in still other cases about 200° C.; the minimum operating temperature in some cases may be about 100° C., in other cases about 125° C. and in still other cases about 150° C. The maximum operating pressure of the second V/L separator in some cases may be about 1000 kPag, in other cases about 900 kPag and in still other cases about 800 kPag; the minimum operating pressure in some cases may be about 10 kPag, in other cases about 20 kPag and in still other cases about 30 kPag.

The third V/L separator, vessel (31) in FIG. 1, may be operated over a relatively broad range of temperatures and pressures. For example, the maximum operating temperature of the third V/L separator in some cases may be about 300° C., in other cases about 250° C., and in still other cases about 200° C.; the minimum operating temperature in some cases may be about 100° C., in other cases about 125° C. and in still other cases about 150° C. The maximum operating pressure of the third V/L separator in some cases may be about 500 kPag, in other cases about 150 kPag and in still other cases about 100 kPag; the minimum operating pressure in some cases may be about 1 kPag, in other cases about 10 kPag and in still other cases about 25 kPag.

Embodiments of the continuous solution-phase polymerization process disclosed in FIG. 1 show three V/L separators. However, continuous solution-phase polymerization embodiments may include configurations comprising at least one V/L separator.

The ethylene polymer products produced in the continuous solution-phase polymerization process may be recovered using conventional devolatilization systems that are well known to persons skilled in the art, non-limiting examples include flash devolatilization systems and devolatilizing extruders.

Any reactor shape or design may be used for reactor (11a), R1, and reactor (12a), R2, in FIG. 1; non-limiting examples include unstirred or stirred spherical, cylindrical or tank-like vessels, as well as tubular reactors or recirculating loop reactors.

At commercial scale the maximum volume of R1 in some cases may be about 20,000 gallons (about 75,710 L), in other cases about 10,000 gallons (about 37,850 L) and in still other cases about 5,000 gallons (about 18,930 L). At commercial scale the minimum volume of R1 in some cases may be about 100 gallons (about 379 L), in other cases about 500 gallons (about 1,893 L) and in still other cases about 1,000 gallons (about 3,785 L).

At pilot plant scales reactor volumes are typically much smaller, for example the volume of R1 at pilot scale could be less than about 2 gallons (less than about 7.6 L). In this disclosure the volume of reactor R2 is expressed as a percent of the volume of reactor R1. The upper limit on the volume of R2 in some cases may be about 600% of R1, in other cases about 400% of R1 and in still other cases about 200% of R1. For clarity, if the volume of R1 is 5,000 gallons and R2 is 200% the volume of R1, then R2 has a volume of 10,000 gallons. The lower limit on the volume of R2 in some cases may be about 50% of R1, in other cases about 100% of R1 and in still other cases about 150% of R1.

In the case of continuously stirred tank reactors the stirring rate can vary over a wide range; in some cases, from about 10 rpm to about 2000 rpm, in other cases from about 100 to about 1500 rpm and in still other cases from about 200 to about 1300 rpm.

In this disclosure the volume of R3, the tubular reactor, is expressed as a percent of the volume of reactor R2. The upper limit on the volume of R3 in some cases may be about 500% of R2, in other cases about 300% of R2 and in still other cases about 100% of R2. The lower limit on the volume of R3 in some cases may be about 3% of R2, in other cases about 10% of R2 and in still other cases about 50% of R2.

The “average reactor residence time”, a commonly used parameter in the chemical engineering art, is defined by the first moment of the reactor residence time distribution; the reactor residence time distribution is a probability distribution function that describes the amount of time that a fluid element spends inside the reactor. The average reactor residence time can vary widely depending on process flow rates and reactor mixing, design and capacity. The upper limit on the average reactor residence time of the solution in R1 in some cases may be about 600 seconds, in other cases about 360 seconds and in still other cases about 180 seconds. The lower limit on the average reactor residence time of the solution in R1 in some cases may be about 10 seconds, in other cases about 20 seconds and in still other cases about 40 seconds. The upper limit on the average reactor residence time of the solution in R2 in some cases may be about 720 seconds, in other cases about 480 seconds and in still other cases about 240 seconds. The lower limit on the average reactor residence time of the solution in R2 in some cases may be about 10 seconds, in other cases about 30 seconds and in still other cases about 60 seconds. The upper limit on the average reactor residence time of the solution in R3 in some cases may be about 600 seconds, in other cases about 360 seconds and in still other cases about 180 seconds. The lower limit on the average reactor residence time of the solution in R3 in some cases may be about 1 second, in other cases about 5 seconds and in still other cases about 10 seconds.

Optionally, additional reactors (e.g., CSTRs, loops or tubes, etc.) could be added to the continuous solution-phase polymerization process embodiment shown in FIG. 1. In this disclosure, the number of reactors is not particularly important; with the proviso that the continuous solution polymerization process comprises at least two reactors that employ at least one single-site catalyst formulation and at least one heterogeneous catalyst formulation.

In operating the continuous solution polymerization process embodiments shown in FIG. 1 the total amount of ethylene supplied to the process can be portioned or split between the three reactors R1, R2 and R3. This operational variable is referred to as the ethylene split (ES), i.e., “ES^{R1}”, “ES^{R2}” and “ES^{R3}” refer to the weight percent of ethylene injected in R1, R2 and R3, respectively; with the proviso that ES^{R1}+ES^{R2}+ES^{R3}=100%. This is accomplished by adjusting the ethylene flow rates in the following streams: stream 2 (R1), stream 7 (R2) and stream 14 (R3). The upper limit on ES^{R1} in some cases is about 60%, in other cases about 55% and in still other cases about 50%; the lower limit on ES^{R1} in some cases is about 10%, in other cases about 15% and in still other cases about 20%. The upper limit on ES^{R2} in some cases is about 90%, in other cases about 80% and in still other cases about 70%; the lower limit on ES^{R2} in some cases is about 20%, in other cases about 30% and in still other cases about 40%. The upper limit on ES^{R3} in some cases is about 30%, in other cases about 25% and in still other cases about 20%; the lower limit on ES^{R3} in some cases is 0%, in other cases about 5% and in still other cases about 10%.

In the present disclosure, the concentration of ethylene in the fresh feed stream RF2 or RF2* is further controlled within a defined range. In some cases, concentration of ethylene in the fresh feed stream RF2 or RF2* is less than or equal to 25 weight percent based on the total weight of the fresh feed RF2 injected into second reactor in unit of time. In some other cases, concentration of ethylene in the fresh feed stream RF2 or RF2* injected into the second reactor R2 is less than 21 weight percent and greater than 17.5 weight percent based on the total weight of said second fresh feed stream injected into said second reactor in unit of time. In still some other cases, concentration of ethylene in the fresh feed stream RF2 or RF2* injected into the second reactor R2 is less than 21 weight percent and greater than 15 weight percent based on the total weight of said second fresh feed stream injected into said second reactor in unit of time.

In operating the continuous solution-phase polymerization process embodiment shown in FIG. 1, the total amount of ethylene converted in each reactor is monitored. The term “Q^{R1}” refers to the percent of the ethylene added to R1 that is converted into a first ethylene polymer by the catalyst formulation. Similarly, Q^{R2} and Q^{R3} represent the percent of the ethylene added to R₂ and R₃ that was converted into second and third ethylene polymers, in the respective reactor. Ethylene conversions can vary significantly depending on a variety of process conditions, e.g., catalyst concentration, catalyst formulation, impurities and poisons. The upper limit on both Q^{R1} and Q^{R2} in some cases is about 99%, in other cases about 95% and in still other cases about 90%; the lower limit on both Q^{R1} and Q^{R2} in some cases is about 65%, in other cases about 70% and in still other cases about 75%. The upper limit on Q^{R3} in some cases is about 99%, in other cases about 95% and in still other cases about 90%; the lower limit on Q^{R3} in some cases is 0%, in other cases about 5% and in still other cases about 10%. The term “Q^{T}” represents the total or overall ethylene conversion across the entire continuous solution-phase polymerization plant; i.e., Q^{T}=100×[weight of ethylene in the polymer product]/([weight of ethylene in the polymer product]+ [weight of unreacted ethylene]). The upper limit on Q^{T} in some cases is about 99%, in other cases about 95% and in still other cases about 90%; the lower limit on Q^{T} in some cases is about 75%, in other cases about 80% and in still other cases about 85%.

Optionally, one or more C₃ to C₁₀ α-olefins may be added to the continuous solution-phase polymerization process disclosed herein. If added, the α-olefin may be proportioned or split between R1, R2 and R3. This operational variable is referred to as the comonomer split (CS), i.e., “CS^{R1}”, “CS^{R2}” and “CS^{R3}” refer to the weight percent of α-olefin comonomer that is injected in R1, R2 and R3, respectively; with the proviso that CS^{R1}+CS^{R2}+CS^{R3}=100%. This is accomplished by adjusting α-olefin flow rates in the following streams: stream (3), stream (8) and stream (15). The upper limit on CS^{R1} in some cases is 100% (i.e., 100% of the α-olefin is injected into R1), in other cases about 95% and in still other cases about 90%. The lower limit on CS^{R1} in some cases is 0% (ethylene homopolymer produced in R1), in other cases about 5% and in still other cases about 10%. The upper limit on CS^{R2} in some cases is about 100% (i.e., 100% of the α-olefin is injected into reactor 2), in other cases about 95% and in still other cases about 90%. The lower limit on CS^{R2} in some cases is 0%, in other cases about 5% and in still other cases about 10%. The upper limit on CS^{R3} in some cases is 100%, in other cases about 95% and in still other cases about 90%. The lower limit on CS^{R3} in some cases is 0%, in other cases about 5% and in still other cases about 10%. In case where more than one C₃ to C₁₀ &-olefins are added to the continuous solution-phase polymerization process, the comonomer split is reported separately for each C₃ to C₁₀ α-olefins.

In some cases, the one or more C₃ to C₁₀ α-olefins is injected into the second reactor via the fresh feed stream RF2 or RF2* at a relative concentration to ethylene of greater than or equal to 0.15 and less than or equal to 2 based on the ratio of ethylene weight precent and the one or more C₃ to C₁₀ α-olefins weigh precent in the fresh feed stream RF2 or RF2*. In some other cases, the one or more C₃ to C₁₀ α-olefins is injected into the second reactor via the fresh feed stream RF2 or RF2* at a relative concentration to ethylene of greater than or equal to 0.15 and less than or equal to 1 based on the ratio of ethylene weight precent and the one or more C₃ to C₁₀ α-olefins weigh precent in the fresh feed stream RF2 or RF2*.

In the continuous polymerization processes described in this disclosure, polymerization is terminated by adding a catalyst deactivator. The embodiment shown in FIG. 1 show catalyst deactivation occurring either: (a) upstream of the tubular reactor by adding a catalyst deactivator A from catalyst deactivator tank (18A), or; (b) downstream of the tubular reactor by adding a catalyst deactivator B from catalyst deactivator tank 18B. Catalyst deactivator tanks 18A and 18B may contain neat (100%) catalyst deactivator, a solution of catalyst deactivator in a solvent, or a slurry of catalyst deactivator in a solvent. The chemical composition of catalyst deactivator A and B may be the same, or different. Non-limiting examples of suitable solvents include linear or branched C₅ to C₁₂ alkanes. In this disclosure, how the catalyst deactivator is added is not particularly important. Once added, the catalyst deactivator substantially stops the polymerization reaction by changing active catalyst species to inactive forms. Suitable deactivators are well known in the art, non-limiting examples include: amines (e.g., U.S. Pat. No. 4,803,259 to Zboril et al.); alkali or alkaline earth metal salts of carboxylic acid (e.g., U.S. Pat. No. 4,105,609 to Machan et al.); water (e.g., U.S. Pat. No. 4,731,438 to Bernier et al.); hydrotalcites, alcohols and carboxylic acids (e.g., U.S. Pat. No. 4,379,882 to Miyata); or a combination thereof (e.g., U.S. Pat. No. 6,180,730 to Sibtain et al.). Carboxylic acids that are suitable as catalyst deactivators include: RCO₂H, where R is a linear or branched hydrocarbyl group containing 5 to 20 carbon atoms.

In this disclosure the quantify of catalyst deactivator added was determined by the following catalyst deactivator molar ratio: 0.3≤(catalyst deactivator)/((total catalytic metal)+(alkyl aluminum co-catalyst)+(aluminum alkyl))≤2.0; where the catalytic metal is the total moles of metal A originating from the bridged metallocene catalyst formulation, metal B originating from the first heterogenous catalyst formulation and optional metal C originating from the second heterogenous catalyst formulation. The upper limit on the catalyst deactivator molar ratio may be about 2, in some cases about 1.5 and in other cases about 0.75. The lower limit on the catalyst deactivator molar ratio may be about 0.3, in some cases about 0.35 and in still other cases about 0.4. In general, the catalyst deactivator is added in a minimal amount such that the catalyst is deactivated and the polymerization reaction is quenched.

Referring to the embodiment shown in FIG. 1; prior to entering the first V/L separator, a passivator or acid scavenger is added to deactivated solution A or B to form a passivated solution, i.e., passivated solution stream 23. Passivator tank 22 may contain neat (100%) passivator, a solution of passivator in a solvent, or a slurry of passivator in a solvent. Non-limiting examples of suitable solvents include linear or branched C₅ to C₁₂ alkanes. In this disclosure, how the passivator is added is not particularly important. Suitable passivators are well known in the art, non-limiting examples include alkali or alkaline earth metal salts of carboxylic acids or hydrotalcites. The quantity of passivator added can vary over a wide range. In this disclosure the molar quantity of passivator added was determined by the total moles of chloride compounds added to the solution process, i.e., the chloride compound “component (vi)” plus the metal compound “compound (vii)”. Optionally, a first and second chloride compound and a first and second metal compound may be used, i.e., to form the first and second heterogeneous catalyst formulations; in this case the amount of passivator added is determined by the total moles of all chloride containing compounds. The upper limit on passivator mole ratio (moles passivator)/(total chlorides) molar ratio may be 20, in some cases 15 and in other cases 10. The lower limit on the (passivator)/(total chlorides) molar ratio may be about 0.2, in some cases about 0.4 and in still other cases about 0.8. In general, the passivator is added in the minimal amount to substantially passivate the deactivated solution.

### First Ethylene Polymer

The first ethylene polymer is produced with a bridged metallocene catalyst formulation. Referring to the embodiment shown in FIG. 1, if the optional α-olefin is not added to reactor 1 (R1), then the ethylene polymer produced in R1 is an ethylene homopolymer. If an α-olefin is added, the weight ratio of α-olefin and ethylene added to the first reactor is one parameter to control the density of the first ethylene polymer. The upper limit on this weight ratio (α-olefin/ethylene)^{R1} may be about 3; in other cases, about 2 and in still other cases about 1. The lower limit on (α-olefin/ethylene)^{R1} may be 0; in other cases, about 0.25 and in still other cases about 0.5. Hereafter, the symbol “σ¹” refers to the density of the first ethylene polymer produced in R1. The upper limit on σ¹ may be about 0.975 g/cm³; in some cases, about 0.965 g/cm³ and; in other cases, about 0.955 g/cm³. The lower limit on σ¹ may be about 0.855 g/cm³, in some cases about 0.865 g/cm³, and; in other cases, about 0.875 g/cm³.

Methods to determine the CDBI₅₀ (composition distribution branching index) of an ethylene erpolymer are well known to those skilled in the art. The CDBI₅₀, expressed as a percent, is defined as the percent of the ethylene polymer whose comonomer composition is within 50% of the median comonomer composition. It is also well known to those skilled in the art that the CDBI₅₀ of ethylene polymers produced with metallocene catalyst formulations are higher relative to the CDBI₅₀ of α-olefin containing ethylene polymers produced with heterogeneous catalyst formulations. The upper limit on the CDBI₅₀ of the first ethylene polymer (produced with a bridged metallocene catalyst formulation as described herein above) may be about 98%, in other cases about 95% and in still other cases about 90%. The lower limit on the CDBI₅₀ of the first ethylene polymer may be about 70%, in other cases about 75% and in still other cases about 80%.

As is well known to those skilled in the art the M_{w}/Mₙ of ethylene polymers produced with bridged metallocene catalyst formulations are lower relative to ethylene polymers produced with heterogeneous catalyst formulations. Thus, in the embodiments disclosed, the first ethylene polymer has a lower M_{w}/Mₙ relative to the second ethylene polymer; where the second ethylene polymer is produced with a heterogeneous catalyst formulation. The upper limit on the M_{w}/Mₙ of the first ethylene polymer may be about 2.8, in other cases about 2.5 and in still other cases about 2.2. The lower limit on the M_{w}/Mₙ the first ethylene polymer may be about 1.7, in other cases about 1.8 and in still other cases about 1.9.

The first ethylene polymer contains catalyst residues that reflect the chemical composition of the bridged metallocene catalyst formulation used for its synthesis. Those skilled in the art will understand that catalyst residues are typically quantified by the parts per million of metal in the first ethylene polymer, where metal refers to the metal in component (a) or component (A); hereafter this metal will be referred to “metal A”. As recited earlier in this disclosure, non-limiting examples of metal A include Group 4 metals, titanium, zirconium and hafnium. The upper limit on the ppm of metal A in the first ethylene polymer may be about 1.0 ppm, in other cases about 0.9 ppm and in still other cases about 0.8 ppm. The lower limit on the ppm of metal A in the first ethylene polymer may be about 0.01 ppm, in other cases about 0.1 ppm and in still other cases about 0.2 ppm.

The amount of hydrogen added to R1 can vary over a wide range allowing the continuous solution-phase process to produce first ethylene polymers that differ greatly in melt index, hereafter I₂¹ (melt index is measured at 190° C. using a 2.16 kg load following the procedures outlined in ASTM D1238). This is accomplished by adjusting the hydrogen flow rate in stream 4 (as shown in FIG. 1). The quantity of hydrogen added to R1 is expressed as the parts-per-million (ppm) of hydrogen in R1 relative to the total mass in reactor R1; hereafter H₂^{R1} (ppm). In some cases, H₂^{R1} (ppm) ranges from about 50 ppm to 0 ppm, in other cases from about 25 ppm to 0 ppm, in alternative cases from about 10 to 0 and in still other cases from about 2 ppm to 0 ppm.

The upper limit on I₂¹ may be about 200 dg/min, in some cases about 100 dg/min; in other cases, about 50 dg/min, and; in still other cases about 1 dg/min. The lower limit on I₂¹ may be about 0.01 dg/min, in some cases about 0.05 dg/min; in other cases, about 0.1 dg/min, and; in still other cases about 0.5 dg/min.

The upper limit on the weight percent (wt %) of the first ethylene polymer in the ethylene polymer product may be about 60 wt %, in other cases about 55 wt % and in still other cases about 50 wt %. The lower limit on the wt % of the first ethylene polymer in the ethylene polymer product may be about 15 wt %; in other cases, about 25 wt % and in still other cases about 30 wt %.

### Second Ethylene Polymer

Referring to the embodiments shown in FIG. 1, if optional «-olefin is not added to reactor 12a (R2) either through fresh α-olefin stream 8 or carried over from reactor 11a (R1) in stream 11e (in series mode), then the ethylene polymer produced in reactor 12a (R2) is an ethylene homopolymer. If an optional α-olefin is present in R2, the weight ratio of «-olefin and ethylene in the second reactor is one parameter to control the density of the second ethylene polymer produced in R2; namely (α-olefin/ethylene)^{R2}. The upper limit on (α-olefin/ethylene)^{R2} may be about 3; in other cases, about 2 and in still other cases about 1. The lower limit on (α-olefin/ethylene)^{R2} may be 0; in other cases, about 0.25 and in still other cases about 0.5. This should be noted that this ratio is different from the relative concentration of α-olefin to ethylene defined based on the ratio of ethylene weight precent and the α-olefins weigh precent in said fresh feed stream RF2 injected to the second reactor—e.g., due to passing the first exit into the second reactor, etc. Hereafter, the symbol “σ²” refers to the density of the ethylene polymer produced in R2. The upper limit on σ² may be about 0.975 g/cm³; in some cases, about 0.965 g/cm³ and; in other cases, about 0.955 g/cm³. Depending on the heterogeneous catalyst formulation used, the lower limit on σ² may be about 0.89 g/cm³, in some cases about 0.90 g/cm³, and; in other cases, about 0.91 g/cm³.

A heterogeneous catalyst formulation is used to produce the second ethylene polymer. If the second ethylene polymer contains an α-olefin, the CDBI₅₀ of the second ethylene polymer is lower relative to the CDBI₅₀ of the first ethylene polymer that was produced with a bridged metallocene catalyst formulation. In an embodiment of this disclosure, the upper limit on the CDBI₅₀ of the second ethylene polymer (that contains an α-olefin) may be about 70%, in other cases about 65% and in still other cases about 60%. In an embodiment of this disclosure, the lower limit on the CDBI₅₀ of the second ethylene polymer (that contains an α-olefin) may be about 45%, in other cases about 50% and in still other cases about 55%. If an α-olefin is not added to the continuous solution-phase polymerization process the second ethylene polymer is an ethylene homopolymer. In the case of a homopolymer, which does not contain «-olefin, one can still measure a CDBI₅₀ using TREF. In the case of a homopolymer, the upper limit on the CDBI₅₀ of the second ethylene polymer may be about 98%, in other cases about 96% and in still other cases about 95%, and; the lower limit on the CDBI₅₀ may be about 88%, in other cases about 89% and in still other cases about 90%. It is well known to those skilled in the art that as the α-olefin content in the second ethylene polymer approaches zero, there is a smooth transition between the recited CDBI₅₀ limits for the second ethylene polymers (that contain an «-olefin) and the recited CDBI₅₀ limits for the second ethylene polymers that are ethylene homopolymers. Typically, the CDBI₅₀ of the first ethylene polymer is higher than the CDBI₅₀ of the second ethylene polymer.

The M_{w}/Mₙ of second ethylene polymer is higher than the M_{w}/Mₙ of the first ethylene polymer. The upper limit on the M_{w}/Mₙ of the second ethylene polymer may be about 4.4, in other cases about 4.2 and in still other cases about 4.0. The lower limit on the M_{w}/Mₙ of the second ethylene polymer may be about 2.2. M_{w}/Mₙ's of 2.2 are observed when the melt index of the second ethylene polymer is high, or when the melt index of the ethylene polymer product is high, e.g., greater than 10 dg/minute. In other cases, the lower limit on the M_{w}/Mₙ of the second ethylene polymer may be about 2.4 and in still other cases about 2.6.

The second ethylene polymer contains catalyst residues that reflect the chemical composition of heterogeneous catalyst formulation. Those skilled in the art with understand that heterogeneous catalyst residues are typically quantified by the parts per million of metal in the second ethylene polymer, where the metal refers to the metal originating from component (vii), i.e., the “metal compound”; hereafter this metal will be referred to as “metal B”. As recited earlier in this disclosure, non-limiting examples of metal B include metals selected from Group 4 through Group 8 of the Periodic Table, or mixtures of metals selected from Group 4 through Group 8. The upper limit on the ppm of metal B in the second ethylene polymer may be about 12 ppm, in other cases about 10 ppm and in still other cases about 8 ppm. The lower limit on the ppm of metal B in the second ethylene polymer may be about 1 ppm, in other cases about 2 ppm and in still other cases about 3 ppm. While not wishing to be bound by any particular theory, in series mode of operation it is believed that the chemical environment within the second reactor deactivates the bridged metallocene catalyst formulation, or; in parallel mode of operation the chemical environment within stream (12d) deactivates the bridged metallocene catalyst formulation.

Referring to the embodiment shown in FIG. 1, the amount of hydrogen added to R₂ can vary over a wide range which allows the continuous solution process to produce second ethylene polymers that differ greatly in melt index, hereafter I₂². This is accomplished by adjusting the hydrogen flow rate in stream 9. The quantity of hydrogen added is expressed as the parts-per-million (ppm) of hydrogen in R2 relative to the total mass in reactor R2; hereafter H₂^{R2} (ppm). In some cases, H₂^{R2} (ppm) ranges from about 100 ppm to 0 ppm, in some cases from about 50 ppm to 0 ppm, in other cases from about 20 ppm to 0 ppm and in still other cases from about 2 ppm to 0 ppm. The upper limit on I₂² may be about 1000 dg/min; in some cases, about 750 dg/min; in other cases about 500 dg/min, and; in still other cases about 200 dg/min. The lower limit on 122 may be about 0.3 dg/min, in some cases about 0.4 dg/min, in other cases about 0.5 dg/min, and; in still other cases about 0.6 dg/min.

The upper limit on the weight percent (wt %) of the second ethylene polymer in the ethylene polymer product may be about 85 wt %, in other cases about 80 wt % and in still other cases about 70 wt %. The lower limit on the wt % of the second ethylene polymer in the ethylene polymer product may be about 30 wt %; in other cases about 40 wt % and in still other cases about 50 wt %.

### Third Ethylene Polymer

Referring to the embodiment shown in FIG. 1, a third ethylene polymer is not produced in reactor 17 (R3) if catalyst deactivator A is added upstream of reactor 17 via catalyst deactivator tank 18A. If catalyst deactivator A is not added and optional α-olefin is not added to reactor 17 either through fresh α-olefin stream 15 or carried over from reactor 12a (R2) in stream 12c (in series mode) or stream 12d (in parallel mode) then the ethylene polymer produced in reactor 17 is an ethylene homopolymer. If catalyst deactivator A is not added and optional «-olefin is present in R3, the following weight ratio determines the density of the third ethylene polymer: (α-olefin/ethylene)^{R3}. In the continuous solution polymerization process (α-olefin/ethylene)^{R3} is one of the control parameters used to produce a third ethylene polymer with a desired density. The upper limit on (α-olefin/ethylene)^{R3} may be about 3; in other cases, about 2 and in still other cases about 1. The lower limit on (α-olefin)/(ethylene)^{R3} may be 0; in other cases, about 0.25 and in still other cases about 0.5. Hereafter, the symbol “σ³” refers to the density of the ethylene polymer produced in R3. The upper limit on σ³ may be about 0.975 g/cm³; in some cases, about 0.965 g/cm³ and; in other cases, about 0.955 g/cm³. Depending on the heterogeneous catalyst formulations used, the lower limit on σ³ may be about 0.89 g/cm³, in some cases about 0.90 g/cm³, and; in other cases, about 0.91 g/cm³. Optionally, a second heterogeneous catalyst formulation may be added to R3.

Typically, the upper limit on the CDBI₅₀ of the optional third ethylene polymer (containing an α-olefin) may be about 65%, in other cases about 60% and in still other cases about 55%. The CDBI₅₀ of an α-olefin containing optional third ethylene polymer will be lower than the CDBI₅₀ of the first ethylene polymer produced with the single-site catalyst formulation. Typically, the lower limit on the CDBI₅₀ of the optional third ethylene polymer (containing an α-olefin) may be about 35%, in other cases about 40% and in still other cases about 45%. If an α-olefin is not added to the continuous solution polymerization process the optional third ethylene polymer is an ethylene homopolymer. In the case of an ethylene homopolymer, the upper limit on the CDBI₅₀ may be about 98%, in other cases about 96% and in still other cases about 95%, and; the lower limit on the CDBI₅₀ may be about 88%, in other cases about 89% and in still other cases about 90%. Typically, the CDBI₅₀ of the first ethylene polymer is higher than the CDBI₅₀ of the third ethylene polymer and second ethylene polymer.

The upper limit on the M_{w}/Mₙ of the optional third ethylene polymer may be about 5.0, in other cases about 4.8 and in still other cases about 4.5. The lower limit on the M_{w}/Mₙ of the optional third ethylene polymer may be about 2.2, in other cases about 2.4 and in still other cases about 2.6. The M_{w}/Mₙ of the optional third ethylene polymer is higher than the M_{w}/Mₙ of the first ethylene polymer. When blended together, the second and third ethylene polymer have a fourth M_{w}/Mₙ which is not broader than the M_{w}/Mₙ of the second ethylene polymer.

The catalyst residues in the optional third ethylene polymer reflect the chemical composition of the heterogeneous catalyst formulation(s) used, i.e., the first and optionally a second heterogeneous catalyst formulation. The chemical compositions of the first and second heterogeneous catalyst formulations may be the same or different; for example, a first component (vii) and a second component (vii) may be used to synthesize the first and second heterogeneous catalyst formulation. As recited above, “metal B” refers to the metal that originates from the first component (vii). Hereafter, “metal C” refers to the metal that originates from the second component (vii). Metal B and optional metal C may be the same, or different. Non-limiting examples of metal B and metal C include metals selected from Group 4 through Group 8 of the Periodic Table, or mixtures of metals selected from Group 4 through Group 8. The upper limit on the ppm of (metal B+metal C) in the optional third ethylene polymer may be about 12 ppm, in other cases about 10 ppm and in still other cases about 8 ppm. The lower limit on the ppm of (metal B+metal C) in the optional third ethylene polymer may be about 0.5 ppm, in other cases about 1 ppm and in still other cases about 3 ppm.

Referring to the embodiment shown in FIG. 1, optional hydrogen may be added to the tubular reactor (R3) via stream 16. The amount of hydrogen added to R3 may vary over a wide range. Adjusting the amount of hydrogen in R3, hereafter H₂^{R3} (ppm), allows the continuous solution process to produce optional third ethylene polymers that differ widely in melt index, hereafter I₂³. The amount of optional hydrogen added to R3 ranges from about 50 ppm to 0 ppm, in some cases from about 25 ppm to 0 ppm, in other cases from about 10 to 0 and in still other cases from about 2 ppm to 0 ppm. The upper limit on I₂³ may be about 2000 dg/min; in some cases, about 1500 dg/min; in other cases about 1000 dg/min, and; in still other cases about 500 dg/min. The lower limit on I₂³ may be about 0.5 dg/min, in some cases about 0.6 dg/min, in other cases about 0.7 dg/min, and; in still other cases about 0.8 dg/min.

The upper limit on the weight percent (wt %) of the optional third ethylene polymer in the ethylene polymer product may be about 30 wt %, in other cases about 25 wt % and in still other cases about 20 wt %. The lower limit on the wt % of the optional third ethylene polymer in the ethylene polymer product may be 0 wt %; in other cases about 5 wt % and in still other cases about 10 wt %.

### Ethylene Polymer Product

The upper limit on the density of the ethylene polymer product may be about 0.975 g/cm³; in some cases, about 0.965 g/cm³ and; in other cases, about 0.955 g/cm³. The lower limit on the density of the ethylene polymer product may be about 0.869 g/cm³, in some cases about 0.879 g/cm³, and; in other cases, about 0.889 g/cm³.

The upper limit on the CDBI₅₀ of the ethylene polymer product may be about 97%, in other cases about 90% and in still other cases about 85%. An ethylene polymer product with a CDBI₅₀ of 97% may result if an α-olefin is not added to the continuous solution polymerization process; in this case, the ethylene polymer product is an ethylene homopolymer. The lower limit on the CDBI₅₀ of an ethylene polymer may be about 20%, in other cases about 40% and in still other cases about 60%.

The upper limit on the M_{w}/Mₙ of the ethylene polymer product may be about 25, in other cases about 15 and in still other cases about 9. The lower limit on the M_{w}/Mₙ of the ethylene polymer product may be 2.0, in other cases about 2.2 and in still other cases about 2.4.

The catalyst residues in the ethylene polymer product reflect the chemical compositions of the bridged metallocene catalyst formulation employed in R1; the first heterogeneous catalyst formulation employed in R2, and; optionally the first or optionally the first and second heterogeneous catalyst formulation employed in R3. In this disclosure, catalyst residues were quantified by measuring the parts per million of catalytic metal in the ethylene polymer products. In addition, the elemental quantities (ppm) of magnesium, chlorine and aluminum were quantified. Catalytic metals originate from two or optionally three sources, specifically: 1) “metal A” that originates from component (i) that was used to form the single-site catalyst formulation; (2) “metal B” that originates from the first component (vii) that was used to form the first heterogeneous catalyst formulation, and; (3) optionally “metal C” that originates from the second component (vii) that was used to form the optional second heterogeneous catalyst formulation. Metals A, B and C may be the same or different. In this disclosure the term “total catalytic metal” is equivalent to the sum of catalytic metals A+B+C. Further, in this disclosure the terms “first total catalytic metal” and “second total catalyst metal” are used to differentiate between the first ethylene polymer product of this disclosure and a comparative “polyethylene composition” that were produced using different catalyst formulations.

The upper limit on the ppm of metal A in the ethylene polymer product may be about 0.6 ppm, in other cases about 0.5 ppm and in still other cases about 0.4 ppm. The lower limit on the ppm of metal A in the ethylene polymer product may be about 0.001 ppm, in other cases about 0.01 ppm and in still other cases about 0.03 ppm. The upper limit on the ppm of (metal B+metal C) in the ethylene polymer product may be about 11 ppm, in other cases about 9 ppm and in still other cases about 7 ppm. The lower limit on the ppm of (metal B+metal C) in the ethylene polymer product may be about 1 ppm, in other cases about 2 ppm and in still other cases about 3 ppm.

In some embodiments, ethylene polymers may be produced where the catalytic metals (metal A, metal B and metal C) are the same metal; a non-limiting example would be titanium. In such embodiments, the ppm of (metal B+metal C) in the ethylene polymer product is calculated using equation (VII):

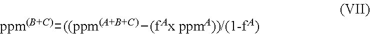

where: ppm^{(B+C)} is the calculated ppm of (metal B+metal C) in the ethylene polymer product; ppm^{(A+B+C)} is the total ppm of catalyst residue in the ethylene polymer product as measured experimentally, i.e., (metal A ppm+metal B ppm+metal C ppm); f^{A} represents the weight fraction of the first ethylene polymer in the ethylene polymer product, f^{A} may vary from about 0.15 to about 0.6, and; ppm^{A} represents the ppm of metal A in the first ethylene polymer. In equation (VII) ppm^{A} is assumed to be 0.35 ppm.

Embodiments of the ethylene polymer products disclosed herein have lower catalyst residues relative to the polyethylene polymers described in U.S. Pat. No. 6,277,931. Higher catalyst residues in U.S. Pat. No. 6,277,931 increase the complexity of the continuous solution polymerization process; an example of increased complexity includes additional purification steps to remove catalyst residues from the polymer. In contrast, in the present disclosure, catalyst residues are not removed. In this disclosure, the upper limit on the total ppm of catalyst residuals (metal A+metal B+optional metal C) in the ethylene polymer product may be about 12 ppm, in other cases about 9 ppm and in still other cases about 7, and; the lower limit on the total ppm of catalyst residuals (metal A+metal B+optional metal C) in the ethylene polymer product may be about 1 ppm, in other cases about 2 ppm and in still other cases about 3 ppm.

The upper limit on melt index of the ethylene polymer product may be about 500 dg/min, in some cases about 400 dg/min; in other cases, about 300 dg/min, and; in still other cases about 200 dg/min. The lower limit on the melt index of the ethylene polymer product may be about 0.3 dg/min, in some cases about 0.4 dg/min; in other cases, about 0.5 dg/min, and; in still other cases about 0.6 dg/min.

### Flexible Manufactured Articles

The ethylene polymer products disclosed herein may be converted into a wide variety of flexible manufactured articles. Non-limiting examples include monolayer or multilayer films, such films are well known to those of ordinary experienced in the art. Non-limiting examples of processes to prepare such films include blown film and cast film processes.

Depending on the end-use application, the disclosed ethylene polymer products may be converted into films that span a wide range of thicknesses. Non-limiting examples include, food packaging films where thicknesses may range from about 0.5 mil (13 μm) to about 4 mil (102 μm), and; in heavy duty sack applications film thickness may range from about 2 mil (51 μm) to about 10 mil (254 μm).

Ethylene polymer products disclosed herein may be used in monolayer films; where the monolayer may contain more than one ethylene polymer product and/or additional thermoplastics; non-limiting examples of thermoplastics include ethylene polymers and propylene polymers. The lower limit on the weight percent of the ethylene polymer product having improved color in a monolayer film may be about 3 wt %, in other cases about 10 wt % and in still other cases about 30 wt %. The upper limit on the weight percent of the ethylene polymer product having improved color in the monolayer film may be 100 wt %, in other cases about 90 wt % and in still other cases about 70 wt %.

The ethylene polymer products having improved color disclosed herein may also be used in one or more layers of a multilayer film; non-limiting examples of multilayer films include three, five, seven, nine, eleven or more layers. The thickness of a specific layer (containing an ethylene polymer product having improved color) within a multilayer film may be about 5%, in other cases about 15% and in still other cases about 30% of the total multilayer film thickness. In other embodiments, the thickness of a specific layer (containing the ethylene polymer product having improved color) within a multilayer film may be about 95%, in other cases about 80% and in still other cases about 65% of the total multilayer film thickness. Each individual layer of a multilayer film may contain more than one ethylene polymer product and/or additional thermoplastics.

Additional embodiments include laminations and coatings, wherein mono or multilayer films containing the disclosed ethylene polymer products having improved color are extrusion laminated or adhesively laminated or extrusion coated. In extrusion lamination or adhesive lamination, two or more substrates are bonded together with a thermoplastic or an adhesive, respectively. In extrusion coating, a thermoplastic is applied to the surface of a substrate. These processes are well known to those experienced in the art.

The ethylene polymer products disclosed herein can be used in a wide range of manufactured articles, e.g., articles that comprise one or more films (monolayer or multilayer). Non-limiting examples of such manufactured articles include: food packaging films (fresh and frozen foods, liquids and granular foods), stand-up pouches, retortable packaging and bag-in-box packaging; barrier films (oxygen, moisture, aroma, oil, etc.) and modified atmosphere packaging; light and heavy duty shrink films and wraps, collation shrink film, pallet shrink film, shrink bags, shrink bundling and shrink shrouds; light and heavy duty stretch films, hand stretch wrap, machine stretch wrap and stretch hood films; high clarity films; heavy-duty sacks; household wrap, overwrap films and sandwich bags; industrial and institutional films, trash bags, can liners, magazine overwrap, newspaper bags, mail bags, sacks and envelopes, bubble wrap, carpet film, furniture bags, garment bags, coin bags, auto panel films; medical applications such as gowns, draping and surgical garb; construction films and sheeting, asphalt films, insulation bags, masking film, landscaping film and bags; geomembrane liners for municipal waste disposal and mining applications; batch inclusion bags; agricultural films, mulch film and green house films; in-store packaging, self-service bags, boutique bags, grocery bags, carry-out sacks and t-shirt bags; oriented films, machine direction and biaxially oriented films and functional film layers in oriented polypropylene (OPP) films, e.g., sealant and/or toughness layers. Additional manufactured articles comprising one or more films containing at least one ethylene polymer product having improved color include laminates and/or multilayer films; sealants and tie layers in multilayer films and composites; laminations with paper; aluminum foil laminates or laminates containing vacuum deposited aluminum; polyamide laminates; polyester laminates; extrusion coated laminates, and; hot-melt adhesive formulations. The manufactured articles summarized in this paragraph contain at least one film (monolayer or multilayer) comprising at least one embodiment of the disclosed ethylene polymer products having improved color. Desired film physical properties (monolayer or multilayer) typically depend on the application of interest. Non-limiting examples of desirable film properties include: optical properties (gloss, haze and clarity), dart impact, Elmendorf tear, modulus (1% and 2% secant modulus), puncture-propagation tear resistance, tensile properties (yield strength, break strength, elongation at break, toughness, etc.) and heat sealing properties (heat seal initiation temperature and hot tack strength). Specific hot tack and heat sealing properties are desired in high speed vertical and horizontal form-fill-seal processes that load and seal a commercial product (liquid, solid, paste, part, etc.) inside a pouch-like package.

The films used in the manufactured articles described in this section may optionally include, depending on its intended use, additives and adjuvants. Non-limiting examples of additives and adjuvants include, anti-blocking agents, primary antioxidants, secondary antioxidants, heat stabilizers, slip agents, processing aids, anti-static additives, colorants, dyes, filler materials, light stabilizers, light absorbers, lubricants, pigments, plasticizers, nucleating agents and combinations thereof. Non-limiting examples of suitable primary antioxidants include Irganox 1010 [CAS Reg. No. 6683-19-8] and Irganox 1076 [CAS Reg. No. 2082-79-3]; both available from BASF Corporation, Florham Park, NJ, U.S.A. Non-limiting examples of suitable secondary antioxidants include Irgafos 168 [CAS Reg. No. 31570-04-4], available from BASF Corporation, Florham Park, NJ, U.S.A.; Weston 705 [CAS Reg. No. 939402-02-5], available from Addivant, Danbury CT, U.S.A. and; Doverphos Igp-11 [CAS Reg. No. 1227937-46-3] available form Dover Chemical Corporation, Dover OH, U.S.A.

### EXAMPLES

### Solution-Phase Polymerization Process

The continuous solution-phase polymerizations in Example 1 and Example 2 were each conducted using a mixed dual catalyst system in a commercial “in-series” multi-reactor solution polymerization process where an ethylene polymer product was made by forming a first ethylene polymer in a first reactor (R1); forming a second ethylene polymer in a second reactor (R2); and forming a third ethylene polymer in a third reactor (R3), where R1, R2 and R3 were configured in series with one another.

The R1 pressure was from about 14 MPa to about 18 MPa; while R2 was operated at a lower pressure to facilitate continuous flow from R1 to R2. Both R1 and R2 were continuously stirred reactors (CSTR's) and were agitated to give conditions in which the reactor contents were well mixed. Two CSTR reactors (R1 and R2) were configured in series followed by the third reactor (R3). The third rector (R3) was a tubular reactor. The process was operated continuously by feeding fresh process solvent, ethylene, 1-octene and hydrogen to the first and second reactors (R1 and R2) and in the removal of product. Methylpentane was used as the process solvent (a commercial blend of methylpentane isomers). Monomer (ethylene) and comonomer (1-octene) were purified prior to addition to the reactor using conventional feed preparation systems-such as contact with various absorption media to remove impurities such as water, oxygen and polar contaminants.

Methylpentane was used as the process solvent (a commercial blend of methylpentane isomers). Monomer (ethylene) and comonomer (1-octene) were purified prior to addition to the reactor using conventional feed preparation systems—such as contact with various absorption media to remove impurities such as water, oxygen and polar contaminants. Ethylene, 1-octene and the process solvent were combined and injected to the reactors R1 and R2 at the ratios shown in Table 1. R1 feed stream temperature in Examples 1 and 2 was controlled at 24.1° C. and 24.0° C., respectively. R2 feed temperature in Examples 1 and 2 was controlled at 68.9° C. and 69.9° C., respectively.

Ethylene concentration in the R1 feed stream was 13.7 weight percent (wt. %) and 12.6 weight percent (wt %.), based on the total weight of the R1 feed stream injected into R1 in unit of time, in Example 1 and Example 2, respectively. Ethylene concentration in the R2 feed stream was 15.7 weight percent (wt. %) and 15.8 weight percent (wt. %), based on the total weight of the R2 feed stream injected into R2 in unit of time, in Example 1 and Example 2, respectively. The relative concentration of 1-octene to ethylene in R1 feed stream was 0.294 wt. %/wt. % and 0.449 wt. %/wt. %, based on the ratio of ethylene weight precent and 1-octene weigh precent in R1 feed stream, in Example 1 and Example 2, respectively. The relative concentration of 1-octene to ethylene in R2 feed stream was 0.782 wt. %/wt. % and 0.903 wt. %/wt. %, based on the ratio of ethylene weight precent and 1-octene weigh precent in R2 feed stream, in Example 1 and Example 2, respectively.

In operating the continuous solution polymerization process shown in Table 1, the total amount of ethylene supplied to the process were portioned or split between the three reactors R1, R2 and R3. In Table 1, this operational variable was called the ethylene split (ES), i.e., ES^{R1}, ES^{R2} and ES^{R3} referred to the weight percent of ethylene injected in R1, R2 and R3, respectively; with the proviso that ES^{R1}+ES^{R2}+ES^{R3}=100%, 1-Octene was also added to the continuous solution polymerization process and was proportioned or split between R1, R2 and R3. In Table 1, this operational variable was called the 1-octene split (OS), i.e., OS^{R1}, OS^{R2} and OS^{R3} referred to the weight percent of 1-octene comonomer that was injected in R1, R2 and R3, respectively; with the proviso that OS^{R1}+OS^{R2}+OS^{R3}=100%.

In operating the continuous solution polymerization process shown in Table 1, the total amount of ethylene converted in each reactor is monitored. The term Q^{R1} referred to the percent of the ethylene added to R1 that was converted into a first ethylene polymer by the catalyst formulation. Similarly, Q^{R2} and Q^{R3} represented the percent of the ethylene added to R2 and residual ethylene flown into R3 from R1 and R2 that were converted into the second and third ethylene polymer, respectively.

In Table 1, the term Q^{T} represented the total or overall ethylene conversion across the entire continuous solution-phase polymerization plant; i.e., Q^{T}=100×[weight of ethylene in the ethylene polymer product]/([weight of ethylene in the ethylene polymer product]+[weight of unreacted ethylene]).

In Examples 1 and 2, the following bridged metallocene catalyst components were used to prepare the first ethylene polymer in the first reactor (R1) configured in series to the second reactor (R2) and the third reactor (R3): component A, diphenylmethylene (cyclopentadienyl) (2,7-di-t-butylfuorenyl) hafnium dimethide [(2,7-tBu₂Flu)Ph₂C(Cp)HfMe₂]; component M, methylaluminoxane (MMAO-07); component B, trityl tetrakis(pentafluoro-phenyl) borate (trityl borate); and component P, 2,6-di-tert-butyl-4-ethylphenol (BHEB). Methylaluminoxane (MMAO-07); and 2,6-di-tert-butyl-4-ethylphenol are premixed in-line and then combined with diphenylmethylene (cyclopentadienyl) (2,7-di-t-butylfuorenyl) hafnium dimethide and trityl tetrakis(pentafluoro-phenyl) borate just before entering the polymerization reactor (R1). The following catalyst component solvents were used: methylpentane for components M and P; and xylene for component A and B. The efficiency of the bridged metallocene catalyst formulation was optimized by adjusting the quantity of component A added to R1 [R1 catalyst (ppm) as recited in Table 1], the mole ratios of the catalyst components—i.e., [M]/[A], [P]/[M] and [B]/[A] as tabulated in Table 1—and the R1 catalyst inlet temperature (not shown in Table 1). The R1 catalyst inlet temperature was controlled at a temperature between 20-40° C.

In Examples 1-2, an in-line Ziegler-Natta catalyst formulation catalyst was used to prepare the second ethylene interpolymer in the second reactor (R2). The in-line Ziegler-Natta catalyst formulation had the following components: butyl ethyl magnesium [component v]; tertiary butyl chloride [component vi]; titanium tetrachloride [component vii]; diethyl aluminum ethoxide [component viii]; and triethyl aluminum [component ix]. Methylpentane was used as the catalyst component solvent and the in-line Ziegler-Natta catalyst formulation was prepared using the following steps and then injected into the second reactor (R2). In step one, a solution of triethylaluminum and butyl ethyl magnesium (Mg:Al=20, mol:mol) was combined with a solution of tertiary butyl chloride and allowed to react for about 30 seconds to produce a MgCl₂ support. In step two, a solution of titanium tetrachloride was added to the mixture formed in step one and allowed to react for about 14 seconds prior to injection into second reactor (R2). The in-line Ziegler-Natta catalyst was activated in the reactor by injecting a solution of diethyl aluminum ethoxide into R2. The efficiency of the in-line Ziegler-Natta catalyst formulation was optimized by adjusting the quantity of titanium tetrachloride added to the reactor—recited as R2 catalyst (ppm) in Table 1, the mole ratios of the catalyst components—i.e., [vi]/[v], [viii]/[vii] and [ix]/[vii] as tabulated in Table 1—and R2 catalyst inlet temperature (not shown in Tables 1A-1C). The R2 catalyst inlet temperature was controlled at a temperature between 20-40° C. The catalyst system and the feed stream were injected into the second reactor (R2) through separate feed lines, on the opposing sides of the reactor about the midpoint between the top and the bottom.

In Examples 1-2, no fresh ethylene, 1-octene, hydrogen and catalyst were pumped into the third reactor. The residual ethylene, residual 1-octene and residual active catalyst(s) entering the third reactor (R3), from upstream reactors R1 and R2, formed the third ethylene polymer in these Examples.

Polymerization in the continuous solution polymerization process was terminated by adding a catalyst deactivator to the third reactor exit stream. A multi-stage phase separation process was employed to recover the ethylene interpolymer product from the process solvent in which the third reactor exit stream was heated and passed through multiple V/L separators configured in series with one another. The polymer-rich stream exiting the last V/L separator, which contained from 94.5 to 96.5 weight percent of the ethylene polymer product, was fed to a twin-screw extruder for addition of additives and pelletization.

The continuous solution-phase polymerizations in Examples 3 and 4 were conducted under substantially identical conditions as those disclosed in Examples 1 and 2 with the exception that: an unbridged single site catalyst with the chemical formula Cp(t-Bu)₃PNTiCl₂ was injected into R1 instead of the hafnocene component A; and the composition, temperature and the total solution rate of the combined feed stream injected into R2 were adjusted to an ethylene concentration of 27.5 wt. %, a 1-octene-to-ethylene relative concentration of 0.20 wt. %/wt. %, a feed stream temperature of 28.0° C. and a feed stream total solution rate of 109 Mg/h in Example 3, and an ethylene concentration of 20.3 wt. %, a 1-octene-to-ethylene relative concentration of 0.19 wt. %/wt. %, a feed stream temperature of 70° C. and a feed stream total solution rate of 149.5 Mg/h in Example 4. The catalyst formulation injected into R1 in Examples 3 and 4 included identical component M, component B, and component P as those used in Examples 1 and 2. The in-line ZN catalyst formulation injected into R2 in Examples 3 and 4 was identical to the in-line ZN catalyst described herein above in the case of Examples 1 and 2. The second reactor R2 was operated at an R2 exit temperature of 188.3° C. and 188.0° C. in Example 3 and Example 4, respectively. Examples 3 and 4 were produced at a target density of 0.919 g/cm³ and a target melt index I₂ of 0.85 dg/min with similar polymerization conditions in the first reactor R₁.

Reactors R1, R2 and R3, in Examples 1-4, were operated under adiabatic conditions. The term “adiabatic” means that no heat is added or removed from polymerization reaction and the reactor temperature was allowed to increase during the course of polymerization.

The ethylene polymer products prepared in Examples 1 through 4 included 750 ppm (by weight) of AO-168, 500 ppm (by weight) of SUMILIZER® GP and 350 ppm (by weight) of AO-1076.

TABLE 1
Continuous solution process parameters-Example 1 and Example 2.

| Sample | Ex. 1 | Ex. 2 |
|---|---|---|
| Target Density (g/cm³) | 0.919 | 0.914 |
| Target Melt Index I₂ (dg/min) | 0.85 | 0.85 |
| Reactor Mode | Series | Series |
| R1 Catalyst | Bridged | Bridged |
| | Met. | Met. |
| R2 Catalyst | Inline | Inline |
| | ZN | ZN |
| R1 component A catalyst (ppm) | 0.428 | 0.635 |
| R1 component (M^{a})/component A mole ratio | 59.641 | 59.963 |
| R1 component (P^{a})/component (M^{a}) mole ratio | 0.200 | 0.200 |
| R1 component (B^{a})/component (a) mole ratio | 1.201 | 1.200 |
| R2 component (vii) catalyst (ppm) | 4.772 | 5.299 |
| R2 component (vi)/component (v) mole ratio | 1.350 | 1.351 |
| R2 component (viii)/component (vii) mole ratio | 1.868 | 1.869 |
| R2 component (ix)/component (vii) mole ratio | 0.368 | 0.371 |
| R3 volume (L) | 7130 | 7130 |
| R1 ethylene split ES^{R1} (%) | 45.0 | 45.0 |
| R2 ethylene split ES^{R2} (%) | 55.0 | 55.0 |
| R3 ethylene split ES^{R3} (%) | 0.0 | 0.0 |
| Ethylene concentration in R1 feed (wt. %) | 13.7 | 12.6 |
| Ethylene concentration in R2 feed (wt. %) | 15.7 | 15.8 |
| 1-Octene/ethylene in R1 feed (wt. %/wt %) | 0.294 | 0.449 |
| 1-Octene/ethylene in R2 feed (wt. %/wt %) | 0.782 | 0.903 |
| Polymer production rate (Mg/h) | 51.4 | 51.5 |
| R1 total solution rate (Mg/h) | 165.5 | 173.0 |
| R2 total solution rate (Mg/h) | 355.1 | 354.6 |
| R3 solution rate (Mg/h) | 360.5 | 359.9 |
| Total solution rate (Mg/h) | 360.5 | 359.9 |
| Total solution rate of R1 feed stream (Mg/h) | 161.4 | 169.0 |
| Total solution rate of R2 feed stream (Mg/h) | 181.8 | 173.6 |
| R1 1-octene split OS^{R1} (%) | 23.3 | 29.0 |
| R2 1-octene split OS^{R2} (%) | 76.6 | 70.9 |
| R3 1-octene split OS^{R3} (%) | 0.0 | 0.0 |
| H₂ concentration in R1 (ppm) | 3.447 | 3.251 |
| H₂ concentration in R2 (ppm) | 8.146 | 2.499 |
| H₂ concentration in R3 (ppm) | 0.000 | 0.000 |
| R1 feed inlet temp (° C.) | 24.1 | 24.0 |
| R2 feed inlet temp (° C.) | 69.9 | 68.9 |
| R3 feed inlet temp(° C.) | 209.9 | 210.4 |
| R1 exit temperature (° C.) | 168.1 | 164.0 |
| R2 exit temperature (° C.) | 208.0 | 203.6 |
| R3 exit temp (° C.) | 219.9 | 215.2 |
| R1 ethylene conversion Q^{R1} (%) | 76.8 | 79.0 |
| R2 ethylene conversion Q^{R2} (%) | 80.3 | 80.0 |
| Total ethylene conversion Q^{T} (%) | 94.1 | 94.1 |

### Film Defects

Absence of defects is a common quality measure in films prepared from polymeric compositions having a thickness of ~130 μm or less. These defects are herein defined according to inclusions which have a distinct phase boundary with the film matrix and transmits light differently from their surrounding material and are detectable by means of an optical scanning system. Those having ordinary skill in the art appreciate that the presence of these defects can cause visually unacceptable films, film breaks or blowouts, and can adversely affect film production equipment.

These defects in the ethylene polymer products prepared according to the present disclosure can be evaluated using well-known techniques where a film sample is extruded and presented to a defect detection system for inspection. The extruder may be configured in at-line operation for continuous quality control during production of the ethylene polymer product, or alternatively in off-line operation where the prepared ethylene polymer product is fed into the extruder in a discreet amount.

In the present disclosure, defects were evaluated in the ethylene polymer products prepared in Examples 1~4 by sampling of 90-180 g of the product every 3 minutes and continuously extruding the sampled material into a 50 μm monolayer cast film prepared at a haul-off speed of 7 meters per minute, a film/winder tension of 6.5 Newtons and an airflow of 6000 Liters per hour. The prepared fil was passed under a high-resolution line-scan camera (FSA-100 OCS camera). The cast extrusion process included a ME-20/2800 V3.4 extruder with five heating zones Z₁ . . . Z₅ with zone temperatures of 210° C./220° C./220° C./220° C./220° C. and a feed throat temperature of 40° C.; an CR-9/G OCS chill roll maintained at 23.0° C.; and an FSA-100 OCS camera with a pixel resolution of 25 μm. The OCS extruder was equipped with a 4:1 compression ratio screw and consisted of no screen packs. The described extrusion parameters were found to not cause polymer degradation which can result into artificial defects in the tested ethylene polymer product. The defect count of various size categories was monitored for the detection of step changes in the ethylene polymer product quality. The size categories were 250-500 μm; 501-750 μm; 751-1000 μm; 1001-1500 μm; 1501-2000 μm; and >2000 μm. Defects size calculations were performed by calculating equivalent circle diameter of defects. The total defects count was reported as a total ppm value defined according to the total area of defects between 250 μm and 2000 μm per a total evaluated area of a rolling window of the produced film 66.4 mm wide and 5.12 m long. To be specific, the total defects count was calculated by multiplying the total area of defects by 10⁶ and dividing the result by the total evaluated area.

The ethylene polymer product produced in Example 1, during operation, had a stable total defects count with an average value of 0.16 ppm. Similarly, the ethylene polymer product produced in Example 2, during operation, had a stable total defects count with an average value of 0.09 ppm. Contrary to Examples 1 and 2, the ethylene polymer product produced in Example 3, during operation, was characterized by an unstable total defects count with intervals reaching total defects count values of greater than (>) 30 ppm. Relative to Example 3, the ethylene polymer product produced in Example 4, during operation, exhibited reduced total defects count values which were consistently less than (<) 1.5 ppm.

Portions of the prepared film samples with elevated defects levels in Example 3 were labeled and the defects larger than 750 μm were further analyzed using a BRUKER HYPERION 3000 Fourier transform infra-red (FTIR) microscope coupled to a Bruker Tensor 27 spectrometer to categorize the observed defects according to one of the categories of non-oxidized polyethylene (NOPE) defects, oxidized polyethylene defects, residual catalyst particles, additive particles, undispersed talc or silicate particles, fibers (clothing or cellulose), and other contaminants such as dust, dirt, oil, etc. In the ethylene polymer product made in Example 3, out of a set of 20 defects characterized using an FTIR microscope, 18 were categorized as NOPE defects based on their FTIR signature. NOPE defects are herein defined according to inclusions that have an FTIR spectrum featuring no additional chemical species other than ethylene and α-olefin monomeric units. NOPE defects are ethylene homo- or copolymers having a weight-average molecular weight exceeding that of the ethylene polymer product and may have a different chemical composition relative to the ethylene polymer product matrix. In the case where a NOPE defect is a homopolymer of ethylene, the observed FTIR spectra of the inclusion is free of peaks known to arise from α-olefin monomeric units. For example, the observed FTIR spectra is devoid of peaks at wavenumbers of about 1378 and 770 cm⁻¹ (1-butene), 1377 and 895 cm⁻¹ (1-hexene), and 1377 cm⁻¹ (1-octene). Additionally, the observed second derivative spectra is devoid of peaks at about 780 cm⁻¹ (1-butene and 1-hexene) and at about 785 and 770 cm⁻¹ (1-octene).

Without wishing to be bound by any theory, NOPE defects can be hypothesized to originate from the feed zone of R2 where the feed reactants (ethylene, hydrogen solvent and optionally 1-octene comonomer) enter the second reactor R2. The degree of polymerization (DPN) for a polymerization reaction is proportional to the total rate of chain propagation reactions and inversely proportional to the total rate of chain transfer/termination reactions. Conditions causing the total rate of chain propagation reactions to increase relative to the total rate of chain transfer/termination reactions result in higher molecular weights. When the ethylene concentration in the feed stream is high (e.g., greater than 25 weight percent based on the total weight of the fresh feed injected into said second reactor in unit of time) at low temperatures (e.g., less than 60° C.), the first heterogeneous catalyst provided to the second reactor briefly encounters a high ethylene concentration at the feed zone and may form a very small amount of a very-high and/or ultra-high MW (i.e., M_{w}s exceeding 10⁶ g/mol). Those skilled in the art would recognize that the intensity of mixing in the second reactor at the feed zone would minimize the duration of the first heterogeneous catalyst exposure to elevated ethylene concentrations. Such feed zone polymer is generally immiscible with the bulk ethylene polymer product and becomes a visual defect in the final film prepared from the ethylene polymer product produced in Example 3. NOPE defects may have a melting temperature measurably (e.g., using techniques such as hot-stage microscopy) higher or lower than the bulk ethylene polymer product matrix and, given their significant molecular weight mismatch with the bulk ethylene polymer product, will remain undispersed under deformation fields experienced during conventional thin film production methods.

Further and more importantly, the low defects count values observed in the case of the ethylene polymer products produced in Examples 1 and 2 can be analyzed in view of the R2 feed stream composition and temperature conditions applied to these Examples. Without wishing to be bound by any theory, high R2 feed stream temperatures and low ethylene concentrations in the R2 feed stream, in Examples 1 and 2, disfavored formation of an ultra-high MW feed zone polymer which resulted in a low content of visual defects in films prepared from the ethylene polymer products prepared in Examples 1 and 2.

The solution-phase polymerization process conducted in Example 4 is important from the perspective that it further substantiates that a) the active catalyst site that formed the NOPE gels in the final ethylene polymer product is the in-line ZN catalyst that is added to R2; and b) consistent with the observations in the case of Examples 1 and 2, low R2 feed stream temperatures and high ethylene concentrations in the R2 feed stream increases the propensity for formation of an ultra-high MW feed zone polymer in R2.

1. A continuous solution-phase polymerization process to provide an ethylene polymer product, wherein the ethylene polymer product comprises a first ethylene polymer and a second ethylene polymer, the process comprising:
a) injecting into a first reactor a bridged metallocene catalyst formulation, a process solvent and ethylene to produce a first exit stream containing the first ethylene polymer in the process solvent; and
b) passing the first exit stream into a second reactor and injecting into the second reactor a first heterogeneous catalyst formulation and a second feed stream to produce a second exit stream containing the second ethylene polymer and the first ethylene polymer in the process solvent, wherein the second feed stream is produced by combining the process solvent and ethylene;
wherein concentration of ethylene in the second feed stream is less than or equal to 25 weight percent based on the total weight of the second feed stream injected into the second reactor in unit of time, and wherein the second feed stream has a temperature of greater than or equal to 60° C. and less than or equal to 90° C.

2. A continuous solution-phase polymerization process to provide an ethylene polymer product, wherein the ethylene polymer product comprises a first ethylene polymer and a second ethylene polymer, the process comprising:
a) injecting into a first reactor a bridged metallocene catalyst formulation, a process solvent and ethylene to produce a first exit stream containing the first ethylene polymer in the process solvent; and
b) injecting into a second reactor a first heterogeneous catalyst formulation and a second feed stream to produce a second exit stream containing the second ethylene polymer in the process solvent, wherein the second feed stream is produced by combining the process solvent and ethylene;
c) and combining the first exit stream and the second exit stream to form a third exit stream;
wherein concentration of ethylene in the second feed stream is less than or equal to 25 weight percent based on the total weight of the second feed stream injected into the second reactor in unit of time, and wherein the second feed stream injected into the second reactor has a temperature of greater than or equal to 60° C. and less than or equal to 90° C.

3. The process of claim 1, wherein the step a) further comprises injecting into the first reactor one or more C₃ to C₁₀ α-olefins.

4. The process of claim 1, wherein the second feed stream in the step b) further comprises one or more C₃ to C₁₀ α-olefins at a relative concentration to ethylene of greater than or equal to 0.15 and less than or equal to 2, based on the ratio of ethylene weight precent and the one or more C₃ to C₁₀ α-olefins weigh precent in the second feed stream injected to the second reactor.

5. The process of claim 3, wherein the C₃ to C₁₀ α-olefins are selected from 1-hexene, 1-octene or a mixture of 1-hexene and 1-octene.

6. The process of claim 1, wherein the second feed stream injected into the second reactor in the step b) comprises hydrogen at a concentration of 0.1 to 20 parts per million based on the total weight of the second feed stream injected into the second reactor in unit of time.

7. The process of claim 1, wherein the bridged metallocene catalyst formulation comprises:
a component A defined by formula (I): 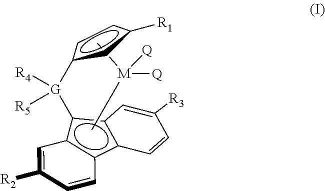
wherein:
M is a group 4 metal selected from titanium, zirconium, or hafnium;
G is a group 14 element selected from carbon, silicon, germanium, tin, or lead;
R₁ is a hydrogen atom, a C₁₋₂₀ hydrocarbyl radical, a C₁₋₂₀ alkoxy radical, or a C₆₋₁₀ aryl oxide radical;
R₂ and R₃ are independently selected from a hydrogen atom, a C₁₋₂₀ hydrocarbyl radical, a C₁₋₂₀ alkoxy radical, or a C₆₋₁₀ aryl oxide radical;
R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical, or a C₆₋₁₀ aryl oxide radical; and
Q is independently an activatable leaving group ligand;
an alumoxane co-catalyst;
a boron ionic activator; and
optionally, a hindered phenol.

8. The process of claim 1, wherein the bridged metallocene catalyst formulation comprises:
a component A defined by formula (II): 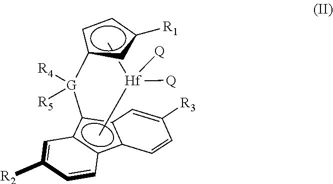
wherein;
G is a group 14 element selected from carbon, silicon, germanium, tin, or lead;
R₁ is a hydrogen atom, a C₁₋₂₀ hydrocarbyl radical, a C₁₋₂₀ alkoxy radical, or a C₆₋₁₀ aryl oxide radical;
R₂ and R₃ are independently selected from a hydrogen atom, a C₁₋₂₀ hydrocarbyl radical, a C₁₋₂₀ alkoxy radical, or a C₆₋₁₀ aryl oxide radical;
R₄ and R₅ are independently selected from a hydrogen atom, an unsubstituted C₁₋₂₀ hydrocarbyl radical, a substituted C₁₋₂₀ hydrocarbyl radical, a C₁₋₂₀ alkoxy radical, or a C₆₋₁₀ aryl oxide radical; and
Q is independently an activatable leaving group ligand;
an alumoxane co-catalyst;
a boron ionic activator; and
optionally, a hindered phenol.

9. The process of claim 7, wherein the boron ionic activator and the component A in the first reactor have a molar ratio from 0.1:1 to 10:1; the alumoxane co-catalyst and the component A in the first reactor have a molar ratio from 1:1 to 1000:1; and the hindered phenol, if present, and the alumoxane cocatalyst in the first reactor have a molar ratio of from 0.0:1 to 10:1.

10. The process of claim 1, wherein the alumoxane co-catalyst is methylalumoxane.

11. The process of claim 1, wherein the boron ionic activator is trityl tetrakis(pentafluoro-phenyl) borate.

12. The process of claim 1, wherein the first heterogeneous catalyst formulations is a first inline Ziegler-Natta catalyst formulation.

13. The process of claim 12, wherein the first inline Ziegler-Natta catalyst formulation is formed in an inline process, the inline process comprising:
forming a first product mixture in a first stage of a first heterogeneous catalyst assembly by combining a stream S1 and a stream S2 and allowing the first product mixture to equilibrate for a HUT-1 seconds; wherein the stream S1 comprises a magnesium compound and an aluminum alkyl in the process solvent, wherein the stream S2 comprises a chloride compound in the process solvent;
forming a second product mixture in a second stage of the first heterogeneous catalyst assembly by combining the first product mixture with a stream S3 and allowing the second product mixture to equilibrate for a HUT-2 seconds; wherein the stream S3 comprises a metal compound in the process solvent; and
forming the first inline Ziegler-Natta catalyst formulation in a third stage of the first heterogeneous catalyst assembly by combining the second product mixture with a stream S4 and allowing the first inline Ziegler-Natta catalyst formulations to equilibrate for a HUT-3 seconds prior to injection into the second reactor, wherein the stream S4 comprises an alkyl aluminum co-catalyst in the process solvent.

14. The process of claim 13, wherein the wherein the HUT-1 is from about 5 seconds to about 70 seconds, the HUT-2 is from about 2 seconds to about 50 seconds and the HUT-3 is from about 0.5 to about 15 seconds.

15. The process of claim 13, wherein a molar ratio of the aluminum alkyl to the magnesium compound in the second reactor is from about 3.0:1 to about 70:1; a molar ratio of the chloride compound to the magnesium compound in the second reactor is from about 1.0:1 to about 4.0:1; a molar ratio of the alkyl aluminum co-catalyst to the metal compound in the second reactor is from about 0:1 to about 10:1; and a molar ratio of the aluminum alkyl to the metal compound in the second is from about 0.05:1 to about 2:1.

16. The process of claim 13, wherein:
the magnesium compound is defined by the formula Mg(R¹)₂, wherein the R¹ groups may be the same or different;
the aluminum alkyl is defined by the formula Al(R³)₃, wherein the R³ groups may be the same or different;
the chloride compound is defined by the formula R²Cl;
the metal compound is defined by the formulas M*(X)ₙ or M*O(X)ₙ, wherein M* represents titanium, zirconium, hafnium, vanadium, niobium, tantalum, chromium, molybdenum, tungsten, manganese, technetium, rhenium, iron, ruthenium, osmium or mixtures thereof, O represents oxygen, X represents chloride or bromide and n is an integer that satisfies the oxidation state of the metal M*, and;
the alkyl aluminum co-catalyst is defined by the formula Al(R⁴)ₚ(OR⁵)_{q}(X)ᵣ, wherein the R⁴ groups may be the same or different, the OR⁵ groups may be the same or different and (p+q+r)=3, with the proviso that p is greater than 0; wherein R¹, R², R³, R⁴ and R⁵ represent hydrocarbyl groups having from 1 to 10 carbon atoms.

17. The process of claim 16, wherein M* in the metal compound represents titanium, zirconium, hafnium, vanadium, chromium or mixtures thereof.

18. The process of claim 12, wherein the first inline Ziegler-Natta catalyst formulation is formed in an inline process, the inline process comprising:
forming a first product mixture in a first stage of a first heterogeneous catalyst assembly by combining a stream S1 and a stream S2 and allowing the first product mixture to equilibrate for a HUT-1 seconds; wherein the stream S1 comprises a magnesium compound and an aluminum alkyl in the process solvent, wherein the stream S2 comprises a chloride compound in the process solvent;
forming a second product mixture in a second stage of the first heterogeneous catalyst assembly by combining the first product mixture with a stream S3 and allowing the second product mixture to equilibrate for a HUT-2 seconds; wherein the stream S3 comprises a metal compound in the process solvent;
forming the first inline Ziegler-Natta catalyst formulation inside the second reactor, wherein:
the second product mixture is equilibrated for an additional HUT-3 seconds in a third stage of the first heterogeneous catalyst assembly and injected into the second reactor; and
a stream S4 comprising an alkyl aluminum co-catalyst in the process solvent is independently injected into the second reactor.

19. The process of claim 18, wherein the HUT-1 is from about 5 seconds to about 70 seconds, the HUT-2 is from about 2 seconds to about 50 seconds and the HUT-3 is from about 0.5 to about 15 seconds.

20. The process of claim 18, wherein a molar ratio of the aluminum alkyl to the magnesium compound in the second reactor is from about 3.0:1 to about 70:1; a molar ratio of the chloride compound to the magnesium compound in the second is from about 1.0:1 to about 4.0:1; a molar ratio of the alkyl aluminum co-catalyst to the metal compound in the second is from about 0:1 to about 10:1; and a molar ratio of the aluminum alkyl to the metal compound in the second is from about 0.05:1 to about 2:1.

21. The process of claim 18, wherein:
the magnesium compound is defined by the formula Mg(R¹)₂, wherein the R¹ groups may be the same or different;
the aluminum alkyl is defined by the formula Al(R³)₃, wherein the R³ groups may be the same or different;
the chloride compound is defined by the formula R²Cl;
the metal compound is defined by the formulas M*(X)ₙ or M*O(X)ₙ, wherein M* represents titanium, zirconium, hafnium, vanadium, niobium, tantalum, chromium, molybdenum, tungsten, manganese, technetium, rhenium, iron, ruthenium, osmium or mixtures thereof, O represents oxygen, X represents chloride or bromide and n is an integer that satisfies the oxidation state of the metal M, and;
the alkyl aluminum co-catalyst is defined by the formula Al(R⁴)ₚ(OR⁵)_{q}(X)ᵣ, wherein the R⁴ groups may be the same or different, the OR⁵ groups may be the same or different and (p+q+r)=3, with the proviso that p is greater than 0; wherein R¹, R², R³, R⁴ and R⁵ represent hydrocarbyl groups having from 1 to 10 carbon atoms.

22. The process of claim 21, wherein M* in the metal compound represents titanium, zirconium, hafnium, vanadium, chromium or mixtures thereof.

23. The process of claim 1, wherein the concentration of ethylene in the second feed stream injected into the second reactor is less than 21 weight percent and greater than 15 weight percent based on the total weight of the second feed stream injected into the second reactor in unit of time.

24. The process of claim 1, wherein the first exit stream has a first temperature T₁ and the second exit stream has second temperature T₂, and wherein T₁ and T₂ satisfy the inequality 45<T₂−T₁<70.

25. The process of claim 1, wherein the process further comprises a step of passing the second exit stream from the step b) into a third reactor and optionally injecting into the third reactor ethylene, a process solvent, one or more α-olefins, hydrogen and a second heterogenous catalyst formulation to produce a fourth exit stream containing an optional third ethylene polymer, the second ethylene polymer and the first ethylene polymer in the process solvent.

26. The process of claim 2, wherein the process further comprises a step of passing the third exit stream from the step c) into a third reactor and optionally injecting into the third reactor ethylene, a process solvent, one or more α-olefins, hydrogen and a second heterogenous catalyst formulation to produce a fourth exit stream containing an optional third ethylene polymer, the second ethylene polymer and the first ethylene polymer in the process solvent.

27. The process of claim 25, wherein the second heterogenous catalyst formulation, if present, is the first inline Ziegler-Natta catalyst.

28. The process of claim 1, wherein the first reactor and the second reactor are operated adiabatically.

29. The process of claim 25, wherein the third reactor is operated adiabatically.
